(19) United States
(12) Patent Application Publication
(10) Pub. No.: US 2022/0188241 A1
(43) Pub. Date: Jun. 16, 2022

(54) Ganaka: A Computer Operating on Models

(71) Applicant: Srinivasa G N PRASANNA, Bengaluru (IN)

(72) Inventor: Srinivasa G N PRASANNA, Bengaluru (IN)

(21) Appl. No.: 17/285,913

(22) PCT Filed: Oct. 21, 2019
(86) PCT No.: PCT/IB2019/001296

§ 371 Date: Apr. 16, 2021

(30) Foreign Application Priority Data
Oct. 19, 2018 (IN) 201841039665

(51) Int. Cl. G06F 12/0897; G06F 16/25; G06F 16/28; G06N 7/00

(52) U.S. Cl. CPC G06F 12/0897; G06N 7/005; G06F 16/288; G06F 16/25

(57) ABSTRACT

This invention deals with a data modelling computer and memory system (extended to a database)—which will be referred to as an Ganaka (computer in Sanskrit). Ganaka is especially useful in processing uncertain data, and Big Data, both of which are major issues in the data processing today, and will be referred to as point data in all that follows.

### 1. FIELD OF THE INVENTION

This invention relates to the software/hardware architecture of computers. It enables a general computer and memory system, to operate in a time and resource efficient fashion, using data and models of data. It is an application of the RISC philosophy, to big-data and machine learning applications.

From one point of view, this invention is an extension of ideas in POLYTOPE AND CONVEX BODY DATABASE as claimed in “POLYTOPE AND CONVEX BODY DATABASE” 2464/CH E/2012, “CONVEX MODEL DATABASES: AN EXTENSION OF POLYTOPE AND CONVEX BODY DATABASE” 201641038613, “DECISION SUPPORT METHODS UNDER UNCERTAINTY” 1677/CHE/2008, “Motion Control Using Electromagnetic Forces”, U.S. Pat. No. 7,348,754, and related applications and incorporates all the ideas therein by reference. This invention further extends convex model databases in representing uncertainty, and in handling “big-data”, both of which are present major issues in data processing.

### 2. BACKGROUND

The invention addresses two significant issues with existing computer systems the difficult of handling huge volumes of data (bigdata), and the dependence of answers on specific realizations of data. Today's Petabyte scale databases pose significant challenges in datacenters, and the answers to many questions depends critically on the exact values present in the data (microstructure), which is not necessarily reflective of large scale properties of the data (macrostructure). The invention addresses these problems.

This invention is a significant extension of the ideas in the EPO number PCT/IN2013/000389, and other applications listed above, and incorporates all the ideas therein by reference.

### 3. DISCUSSION OF THE PRIOR ART

The prior art is restricted to databases using linear models or an ensemble of them. It does not have automatic feature selection, or relations to Markov Random Fields and/or Bayesian Networks, optimized I-structures, automatic summarization, . . . . It does not mention general computers working on models, nor memory systems or input-output systems having models as their fundamental objects.

### 4. ABSTRACT AND SUMMARY OF THE INVENTION

This invention deals with a data modelling computer and memory system (extended to a database) which will be referred to as an Ganaka (computer in Sanskrit). Ganaka is especially useful in processing uncertain data, and Big Data, both of which are major issues in the data processing today, and will be referred to as point data in all that follows.
Definition: A model is a set of point data, and has non-zero measure. The model can be derived from historical data, or in part/full derived independently of historical data, based on apriori information. Typically the model is stored as a linear or nonlinear non-probabilistic model (polyhedral in possibly non-linear features), or a graphical probabilistic model. It can also be a software/hardware module a Java package, an FPGA, an ASIC, . . . . In another language, a model specifies a set in a succinct set-builder form, as opposed to listing all the elements seen, and even those possibly not encountered so far. Ganaka's key strength is in methods to work with concise set builder specifications linear polyhedral specifications, convex specifications, graphical models, etc. . . . . An arbitrary amount of data can be captured in a single invariant specification, once it is correctly estimated.

Ganaka models data, and works with point data and multiple models, in a flexible, integrated fashion. A given computation may specify the use of the point data, or a specific model, or leave the choice of using the point data, or one or more models, to the computer system itself, which will try to do so in an optimal fashion. Storage may be point data, models, and/or both, and similarly for i/o. Ganaka has both a programming language interface and inbuilt algorithms, for controlling the use of either point data, models, or both.

Point data and associated models are kept approximately synchronized, in that the model is capable of generating all data seen so far, with the possible exception of the block(s) of latest data, which are still being incorporated in the model. In the reverse direction, the data should statistically represent all the data samples which can be generated by the model (ignoring a possible sampling bias). This is made precise below. The advantage of such a device is the ability to derive general models from data, and work using these generalizations directly, possibly in conjunction with the data, in a programmable fashion.

FIG. 1 shows an Ganaka, which adds an inference Engine F1_IE_200, to an ALU F1_ALU_100, and a Model Memory F1_MM_400 to a conventional Memory. The Inference engine performs operations on models, which are sets of data. The Model Memory stores models. Similarly the I/O interface communicates either point data (F1_IO_700) or models (F1_MIO_800). The world of data and the world of associated models is kept synchronized, using extensive software-hardware facilities provided for this purpose (including both the programmable controller F1_PC_600, and inbuilt exemplarily machine learning based controller F1_ML_500). The conventional instruction set is extended to include operations on models.

Processing can be performed using only point data as in a conventional ALU, using the model(s) only, or both, depending on the application. Processing for point data is conventional as per the state-of-art. Techniques based on fast algorithms and machine learning are used for processing of models. Hybrids are used when processing is done on both point data and models together. Associations are maintained between point data and associated models. These association links between the domains of point data and models, are either through hard-coded memory allocation, pointers, or any similar method known-in-the state-of-art and extended as described here. Similar association links between the domains of point data, and models, in the presence of I/O, may involve URLs.

Linear and convex models facilitate polynomial time algorithms, but the computer system is not restricted to them. Techniques are presented to optimize processing on an ensemble of models. Specific features are presented facilitating nonlinear statistical machine learning models, based on Markov Chains or their generalizations. The models are generated using state-of-art ML techniques, yielding automatic feature selection, and/or methods based on graphical models. Models can themselves be modelled using more general models, yielding a hierarchy of models.

Ganaka can be implemented partially or completely in the software or hardware, as a Web service, a Dynamic Link Library (DLL), or even an Application Specific Integrated Circuit (ASIC). Some details of the implementation, including pointers, structuring of polytopes as combinations of constraints or other polytopes, using both half-plane and vertex representations, are described in the preceding patents referred to above (PCT/IN2013/000389), and incorporated by reference. Additional details are described in this description.

Working with models in addition to point data saves storage (main memory, disk, . . . ), power, . . . , and also enables more general results to be obtained, instead of the results based on only the specific samples (answers are robust) (see FIG. 2)

In the context of databases, the set theoretic and materialization operators discussed previously are extended in this invention to include non-uniform probability distributions, nonlinear models, and are made tractable using the structure determination methods of statistical learning theory and/or neural networks (Automatic learning using backpropagation, and/or log-linear model).

In summary, the invention offers the following unique facilities
Ganaka uses application specific methods to derive models of point data. Ganaka has an ALU operating on the point data, the associated models, or both, in a tightly coupled fashion. Data can be used to generate models, and/or models can be used to generate new data. Processing can be done using only point data, only associated models, or both. Ganaka can use different modeling methods in different portions of the data, depending on the application.
   These models extend the polyhedral and convex models of our prior patents, to regular polyhedral, graphical and other general models.
   These models can be stored in
      Analytical form if the polyhedra are regular e.g. a tetrahedron is a 3-3-3 solid, with 3 triangles meeting at every vertex.
      Constraint (half-plane) or hybrid half-plane data point form for general polyhedral models.
      Directed and Undirected Graphs for Bayesian Networks and Markov Random Fields.
   Ganaka's facilities for learning models include but are not limited to:
      Determining features from data, and storing the same as a representation of pertinent aspects of the data, from which polyhedral models can be derived as per the earlier state-of-art.
      Deriving graphical models and Markov Random Field representations.
Ganaka includes a memory which stores point data and/or models.
Ganaka includes i/o channels which communicate point data and/or models.
In general, Ganaka's resources of any kind can use both point data and/or models.
Processing of models by Ganaka includes exemplarily performing one and two operand operations on them—e.g. the set theoretic union, intersection, adding, subtracting, taking the cross product, etc. of models.
Specifically for set-theoretic and information-theoretic operations, Ganaka includes a generalized I-structure, which stores results of precomputed operators on them.
   Model specific methods not restricted to linear programming are used to infer set and information theoretic relations in the generalized I-structure.
   Optimal scheduling of evaluation of the I-structure edges is presented, of importance for systems with large number of models.
Ganaka also offers facilities to show an intuitive relation of the model it is working with, to the point data originally used to generate the model.
Ganaka's memory system, is employed in a database which learns models from data, stores them, and offers extended relational algebra facilities on these models. A dataset may be described by a single model, or multiple models for different subsets of the dataset, or different views of the same dataset. Ganaka's i/o system can extend the database facilities for distributed processing of models.
Computer operations are speeded up, and resource/power usage reduced, using these modeling approach of Ganaka.

Ganaka can be applied to images, speech, weather, travel times for trains and/or planes, medical data, graphics, etc.

4.1. Datapoints Versus Models

The concepts of the invention Ganaka, and differences from processing of raw data as in a traditional computer system, a memory system, an i/o system, or an RDBMS, are as depicted in FIG. 3 below. There is a world of data samples (scaling to Petabytes and beyond in big data systems), and another world of data models (many orders of magnitude smaller), and the invention integrates and synchronizes the two. The invention can deal with models, completely independent of data points also.

In all the discussion below, we shall use the words datapoints and datasamples interchangeably, except when a difference is explicitly indicated.

One view to regard data is as manifestation of an underlying generative process a data generation model. The model may be known apriori (e.g. thermal noise in communication systems), or estimated from the data itself, e.g. a Bayesian network, a Markov Random Field, . . . . Referring to FIG. 3, once the data is generated, we can view it in at least two ways, depending on the application
a) Exact reality as in a conventional computer system (filled circles—F3_TR_100) and from which a model can be inferred (dotted lines—F3_ITR_100)
b) Evidence (empty circles—F3_ETR_200) for the underlying model (or models) (thick lines—F3_TR_200), which is reality.

Compared to a conventional computer system, which operates under viewpoint (a), Ganaka facilitates and synchronizes the usage of both viewpoints (a) and (b). In a large portion of the recent work (e.g. streaming databases Jensen et al), models are used to approximate datapoints, corresponding to using models to facilitate viewpoint (a).

Note the contrasting view of truth in the data samples, versus model. Answers produced under viewpoint (a) are at best approximations under viewpoint (b), and vice versa (most of the current state-of-art).

The model may be derived from the samples as evidence but could also be ad-hoc derived from known properties of the system being modelled e.g. flow conservation constraints in networks, deliberately imposed constraints on future events, etc. . . .
A typical but not exclusive assumptions about models is that they include all the observed samples (other than outliers defined in some fashion), and the convex hull of these samples. The exact convex hull for N samples, has a number of facets exponential in N, and approximations can be used for computational tractability.

In viewpoint (b) answers to questions are with respect to models, not with respect to samples. The type of question is different from viewpoint (a)—the input and output parameters are models, which can be regarded as collections of data, represented in a succinct manner. The exact type of model used is application dependent.
In one class of systems (e.g. flow networks, logistics, market behaviour, . . . ) linear constraints on the data (flow conservation, timing constraints, total market size, . . . ) can be used, and if required, estimated from data.
In other systems, quadratic constraints, e.g. energy conservation in lossless systems, are appropriate
In other cases, general constraints on transformed data—e.g. on magnitudes of the Discrete Cosine Transform coefficients, in compressed images, can be used.

When the models are derived from data (e.g. “big-data”) there are typically far fewer models compared to data samples. Depending on the statistics, a Petabyte of data, with 10¹² data samples (each possibly with 100's of dimensions, and taking 1K byte per sample), can be represented by a thousand polytopes (or other models), each representing a billion points, and occupying about a Gigabyte a storage compression of a factor of million. If the models are estimated correctly, they need not change significantly as new data arrives.
When the models are derived from ad-hoc information about the system (e.g. flow-conservation constraints), or models of the future, such a comparison is not meaningful.

Clearly, whenever possible, using models under viewpoint (b) in-place of data samples under viewpoint (a) helps compress storage, increase speed, and reduce power, in the computer system, a technical improvement.

Models being collections of data are sets, and set-theoretic operations of intersection, disjointedness, and subsets are some fundamental operators on them. In layman's terms, the first two are functions of “position and shape”, and the second “position, volume and shape”. The measure of the set (volume for continuous sets, count of elements for discrete sets), is another fundamental property, and operators can be based on the measure of the set, as outlined in the section on measure theory. Note that the count of elements for discrete sets is not the same as the number of observed data points, but the count of all the elements included in the associated data model (typically much higher).

4.2. Ganaka Compared to a Conventional Computer System

As compared to a conventional ALU (say, based on the RISC philosophy), Ganaka takes the view that whenever viewpoint (b) holds, the fundamental quantities of interest are the models, and sample datapoints (chars/integers/floating points/ . . . ) are evidences for the model. Hence any computer system has to explicitly or implicitly deal with the models to analyze/establish the truth. The particular hardware/software architecture is of course dependent on the structure of the models.

4.3. Ganaka Versus a Conventional Memory and i/o System

Just as above, datapoints in a memory system are evidence, and the truth is the model, which has to be stored in memory in some fashion (exemplarily constraints in the case of polytopes, graphs in the case of graphical models, . . . ). It is exactly the same story for i/o and/or a similar resource—we can communicate with point data or models

4.4 Ganaka Versus a Conventional RDBMS.

RDBMS's operate under viewpoint (a). The database embodiment of Ganaka is referred to as an enhanced Convex Model Database (eCMdB), and uses viewpoint (b). It hence cannot be directly compared to an RDBMS (but can be used in a way, to speedup RDBMS queries). The difference between an enhanced CMdB and an RDBMS can be illustrated by a simple select query in pseudo-code, selecting polytopes:
A select query in a eCMdB on a table T and a polytope P:
Select(T, P): Select*from T where T.*intersects P

This select query fetches from the table T, every polytope (say K of them) which intersects with the specified polytope P. Intuitively this means that these polytope models have behavior similar to the model implied by P, when the parameters are in the intersection region (similar approximations from the viewpoint of an RDBMS).

A rough equivalent using an RDBMS requires us to specify P, in terms of its samples pi. Then the select query can be approximated by selecting points in T, which are close to the samples pi (similar evidences from the viewpoint of a CMdB). These points can be regarded as samples of the intersection between these polytopes.
Select(T,pi): Select*from T where min_pi(dist(T.*,pi)<=threshold)

The answer is a set of points in T which are less than threshold distance from at least one point in pi. However, this is dependent on the threshold used for distance between points. These points, when clustered into K-clusters, should form ideally the K polytopes returned by the CMdB, but there is no direct equivalent. The query can have also one/more parameters as sample datapoints themselves.

In the embodiment as a database, feeding a decision support system, Ganaka facilitates better decision support, since it works on models of data, not just (when available) samples of data (where the truth is regarded as the model). Models encompass the entire truth under viewpoint (b), and the available samples are just one set of manifestations of the truth. Working with models makes the answers more robust. If course, both viewpoints can be used in conjunction, and Ganaka has facilities for this.

At the highest level, the entire computer system Ganaka (ALU, Memory, I/O), deals quickly and efficiently, both with individual datapoints (point data, as denoted earlier), and with models, benefiting several applications. In addition to arithmetic/logical operations per second, bytes/words of memory, and words/second of i/o throughput, we deal with model operations per second, number of models stored in memory, and models/second of i/o throughput.

Below we describe several specific embodiment of the invention, but it should be understood that the invention is not limited to these embodiments but covers all others variations of any part or the whole of the invention. The invention may be implemented in computer software, hardware, or firmware, as an ASIC, as an analog device, or whatsoever, and all such variations are covered by this description.

### 5. MODEL SIZE ESTIMATION MEASURE THEORY

A fundamental aspect of Ganaka is modelling of datapoint collections (data aggregates). Collections of datapoints are modelled succinctly as polytopes, convex models, or general models like graphical models. A fundamental property of any collection is its size generalized volume in a collection which is a subset of continuous space, or the number of points in the collection in a discrete collection. Depending on the application, multiple instances of the same item can be counted as a single entity (in non-probabilistic analysis), or different entities (in probabilistic analysis). Methods to define the size of the collection, and algorithms to calculate it in either continuous or discrete spaces, compare sizes of two collections, generate new collections of the same size, are etc., dealt with in Measure theory.

Many applications are often high dimensional, and methods to calculate the generalized volume or count the number of points are computationally expensive. These take time exponential in the number of dimensions, or defining constraints, for continuous variables (Simonovitz, . . . ). If the variables are discrete—and if the convex hull of datapoints/datasamples, is taken as the underlying truth under viewpoint (b), counting the number of integer points possible is #PSPACE complete (this is much larger than the number of samples seen so far).
For structured regions rectangular boxes, ellipsoids, regular and Archimedean polyhedral, analytical methods exist to find the volume (in a continuous space).
For graphical models with sparse dependences, . . . , belief propagation and its generalizations can be used.
Approximations are made for general continuous or discrete collections, e.g. using Monte Carlo Markov Chain methods for general polyhedra, . . . .

The invention uses these methods to derive the volume of models, which is extensively used in the extended relational algebra as presented in our previous patents and patent application and extended to a general computer system Ganaka as outlined in this application.

### 6. BRIEF DESCRIPTION OF THE DRAWINGS

FIG. 1 Modeling Computer Ganaka . . . 7

FIG. 2 Point Data and Associated Models in Ganaka . . . 9

FIG. 3 Contrasting Views of Truth . . . 11

FIG. 4 A data block and associated models) corresponding to different applications. Different blocks can have different models. Models are exemplarily accessed through pointers in a linked list. The head of the linked list is directly accessed through a compressive mapping of the data block (physical/logical) address . . . 20

FIG. 5 Models and associated blocks of datapoints a model points to a CMdB tuple (row), or to a piece of code implementing it, or both. The start-end block addresses of each model are stored with the pointer. Blocks can overlap. Memory Block A has a single single model Model 1 associated with it, and Memory Block B has two models Model 1 and Model 2 associated with it. Model 3 does not have any memory block associated with it currently, but may do so in future. Each model has associated information content, estimated using a variety of techniques. . . . 21

FIG. 6 Datapoint<->Model Link in Ganaka . . . 22

FIG. 7 Hierarchically structured blocks (possibly overlapping), and associated model hierarchy. Pointers are not shown between blocks and associated models for clarity. . . . 23

FIG. 8 Automatic Model Updater in Parallel Core . . . 24

FIG. 9 Ganaka's Inference Engine coupled to Memory . . . 25

FIG. 10 Shared Memory in Ganaka facilitating multiple parallel algorithms working on the same operator, yielding answers, and/or bounds/approximate answers . . . 27

FIG. 11 Structure of Inference Engine . . . 28

FIG. 12 Structure of Inference Engine and ALU in Ganaka . . . 28

FIG. 133 Exemplary Operation of IE in Ganaka . . . 29

FIG. 14 Graphical Model in Ganaka, and associated 3-D Polyhedron showing Y and Z conditionally independent given X . . . 30

FIG. 15 Set Theoretic Relational Algebra in Ganaka using comparison of rectangles (intersecting polyhedral) . . . 31

FIG. 16 Alternative Materializations in Ganaka preserving volume. Alternative ‘materializations based on changes only in y and z, preserving y-z area (Non-Convex Polyhedron) . . . 31

FIG. 17 Set Theoretic Operations in Ganaka from Graphical Models . . . 32

FIG. 18 General Operations over Bayesian Networks . . . 33

FIG. 19 Support region of a PDF in Ganaka is a continuous scaling of hypercubes of variables which are conditionally independent. . . . 33

FIG. 20 A General Graphical Model . . . 34

FIG. 21 Showing a Markov Random Field in Ganaka, in variables x1, x2 in Clique 1, y1, y2 in Clique 2, and separator AB. . . . 36

FIG. 22 Markov Random Field showing two/three cliques . . . 37

FIG. 23 Model Layout in Memory . . . 39

FIG. 24 An embodiment of Ganaka . . . 42

FIG. 25 Memory structures accessed by Ganaka . . . 43

FIG. 26: Garbage Collector Dynamics. A set of models is first created, improved by addition of a graphical model, and then compressed by eliminating one or more models to reclaim space, or merging two models to create the convex hull of both, or a bounding box of the same volume. This is under control of an exemplarily garbage collection dedicated processor, exemplarily using machine learning. . . . 47

FIG. 27 Diagram of a modeling memory, which compresses data, and can be used as a database. Note certain pairs are approximated by convex polytopes (RED bold) or non-convex regions (BLUE italics). . . . 49

FIG. 28 Memory Embodiment as data compressor and regenerator . . . 52

FIG. 29 Polyhedral modeling of data. Each tuple in the CmdB corresponds to a collection of datapoints in an RDBMS . . . 53

FIG. 30 Improved Modeling compared to Earlier Invention, with some polyhedra replaced by graphical models, and additional data being modeled . . . 54

FIG. 31 Multiple models for blocks of datapoints, linked to respective blocks . . . 54

FIG. 32 Two different dependencies among the same variables x, y, z . . . 55

FIG. 33 CmdB with Probability for Each Model . . . 56

FIG. 34 One embodiment of part of the invention showing a high-level view of a CMdB, with an I-structure and an associated Graphical Model of the data. A namespace manager which manages mappings between different variable names in the namespace is also present . . . 58

FIG. 35 “Ganaka as a database, with Nonlinear feature extraction coupled to raw data, and producing outputs” . . . 58

FIG. 36 Showing graphical models corresponding to a single row or a plurality of rows. . . . 60

FIG. 37 I-structure Nodes and Edges, stored using adjacency list representation. The model field may be a pointer or may include constraints and other information in-place. . . . 61

FIG. 38 I-structure Nodes and Edges, showing partially computed relationships, and pointers to associated state. . . . 62

FIG. 39 Showing an I-structure in Memory . . . 63

FIG. 40 I-structure as DAG of polytope nodes . . . 64

FIG. 41 Ordering of nodes for building I-structure shown in FIG. 20, say Ordering 1. . . . 65

FIG. 42 Ordering of nodes for building I-structure shown in Error! Reference source not found., say Ordering 1. . . . 65

FIG. 438 Another Ordering of nodes for building I-structure shown in FIG. 20, say Ordering 2 . . . 66

FIG. 44 Another Ordering of nodes for building I-structure shown in Error! Reference source not found., say Ordering 2. . . . 66

FIG. 45 I-structure optimization modules in Ganaka . . . 69

FIG. 46 I-structure optimization modules in Ganaka . . . 69

FIG. 47 I-structure optimization modules in Ganaka Error! Bookmark not defined. . . . 69

FIG. 48 Showing Nonlinear transformations and inverse transformations using CMdB Error! Bookmark not defined.

FIG. 495 Non-linear model . . . 76

FIG. 50 Non-linear model Error! Bookmark not defined.

FIG. 517 Ganaka Program . . . 80

FIG. 52 Namespace Manager Error! Bookmark not defined.

FIG. 539 Showing database utility for railway schedule conflict validation . . . 84

FIG. 540 Venn diagram showing the inter-relationships between the various sets . . . 85

### 7. DETAILED DESCRIPTION OF THE INVENTION

A first embodiment of Ganaka is a computer system. A special case is a memory device embodiment, and a use of the memory device, results in a database embodiment. The extension to an i/o device is exactly analogous to the memory device (models are communicated, in conjunction with point data).

### 8. A FIRST EMBODIMENT AS A COMPUTER SYSTEM: GANAKA

A general view of this invention is as a computer system efficiently handing both point data and models as the basic data objects. As opposed to architectures discussing data in terms of bytes/words/objects, we additionally talk about models (which represent aggregates of data, in a computationally convenient/tractable, possibly human-understandable “set-builder” form). A model ideally specifies the underlying system which generates the available data, and also data which is not present, but can possibly be generated from the system (unseen possibilities).

Performance has to be exemplarily measured in (standard) models analyzed per second for the ALU (here called the inference engine), models stored per Megabyte of memory, and models transmitted per second over interconnect. Compared to prior state-of-art in model based computing [e.g. ModelarDB, . . . ], the invention brings in set-theoretic and information theoretic concepts into the architecture of computers. Sets here have non-zero measure (volume/count in continuous/discrete parameters).

Datapoints can be analyzed to configure/improve models, and estimate answers of model operators. Models can be sampled to obtain new datapoints, and models can be analyzed/optimized to obtain answers to set/information theoretic operators.

The models are designed on an application specific basis ranging from simply listing all the datapoints, a statistical summary, an enclosing polytope/convex body to facilitate (convex) optimizations, a graphical model facilitating machine learning/ . . . , etc.

8.1. Types of Models Some examples of models are:

8.1.1. Datapoints and Intervals
The simplest case is when the model is a collection of datapoints, in which case processing is done as per current practice on a conventional ALU.
If we have independent intervals instead of datapoints, earlier known methods like unum (REF) can be used, for computation.
When the datapoints become correlated in their variations, more sophisticated methods are needed, as given below.

8.1.2. Regular, Archimedean and Other Structured Objects

Regular and Archimedean polyhedra (Tetrahedron, Cube, Octahedron, Icosahedron, Dodecahedron, . . . , and their higher dimensional analogs) are conveniently described by a few parameters, and analytical equations for their facets, volume, . . . can be written down. Other examples are simplexes, simplical polyhedra, ellipsoids, cones, . . . .
Simple extensions include simplexes, polyhedra with a single substitutive/complementary constraint, etc.

As such, both set theoretic and information theoretic operators on such models (and scaled and rotated versions, possibly differently scaled in different dimensions, . . . ) can be performed analytically.

8.1.3 General Polyhedra

Set and Information Theoretic Operations on general polyhedra, are handled using linear and integer linear programming, and speeded up using I-structures, as described partially in our preceding patent applications, and extended further here.

8.1.4. Statistical Models Including Graphical Models

General canonical graphical models are probabilistic, and generally not convex. Using the indicator function of the non-zero support of the PDF enables us to use extended relational algebra techniques.
These include graphical model(s) of the data (a Markov Random Field and/or a Bayesian Network), factor-graphs, . . . . The graphical model is exemplarily derived by any one of a variety of statistical learning techniques (log-linear analysis, contrastive-divergence, . . . ), in a supervised/unsupervised method.
Specifically, the graphical model allows fast inferences of set intersection/subsetness, without requiring full scale linear programming. The factor graph approaches allow the information content (the measure of the polyhedral volume) to be estimated, using a variety of statistical techniques.
   Partly computed operator results (especially for subsets/information content) can be stored for later access.
The graphical model can be derived from data, or from known apriori constraints (e.g. flow conservation), exemplarily following the techniques in Petitjean below (and similar ones), where an increasingly complex model is tried in sequence (forward selection).
   Scaling log-linear analysis to high-dimensional data, Francois Petitjean, Geoffrey I. Webb and Ann E. Nicholson, IEEE ICDM 2013

8.1.5 General Models

A general model can be implemented as a pointer to a general microcoded/nanocoded module. Models can have information content stored together with them, estimated as per our earlier patents/patent applications, and extended in this application (Sections 8.2, 8.3, 10. Models can be stored in the memory structure itself, or elsewhere.
Models can be recursively modeled (like paging a multi-level page table).

Models can be convexified inner/outer approximations of other models (Bayesian/Markov Random Fields), leading to associated simplifications in I-structure computations.
The approximations can be polytopes, as per our earlier patents regarding a database embodiment.
These polytopes in the memory can be chosen to have standard easy to implement constraints e.g. substitutive, complementary, . . . .

Operators dealing with a mixture of model types can be implemented by converting the simpler models to the most general types (exemplarily graphical models). Other methods also exist.

### Features of General Models

Ganaka additionally offers a means of automatically recognizing features of a dataset satisfying a general model, exemplarily using machine learning techniques like neural networks/trainable MRF/Bayesian Networks (log-linear model—Petitjean 2013)

Optionally, it is capable of recognizing that the volume of the resulting feature space spanned by the dataset, should be small to get a good model, and uses said volume as a minimizing criterion to obtain good features in a supervised, unsupervised, or semi-supervised learning paradigm.
These features can be designed to be human understandable also.
Ganaka optionally stores the resultant feature set, and models of blocks of the dataset, in a memory system, analogous to the state-of-art of the CMdB and blocks of the CMdB, as per the preceding patents and patent applications.

8.1.6. Summary Models

In addition, Ganaka automatically derives linear or convex summaries of the dataset, and immediately offers their set theoretic relationship with the original data (summaries which are linear convex combination).
Since the process can be repeated for the summaries themselves, the invention automatically creates a hierarchical model, with increasing levels of detail.
Important special cases of summarization include:
   Sampling every kth element in the input data.
   Averaging part or whole of a data block

Yᵢ=Σⱼxᵢⱼ
Weighted averaging of part or whole of a data block

Yᵢ=Σⱼwᵢⱼxᵢⱼ

The multiple data model classes facilitate optimization (for increased speed, lower power consumption, reduced space, . . . ) of both set and information theoretic operators, and associated I-structure inference techniques. In several cases, heavyweight set-theoretic operators based on linear programming are replaced by analytical methods, lower complexity methods like graph inference, . . . . Computational Intractability of information theoretic operators is eliminated in several cases.

FIG. 5 illustrates the advantages of a large class of models. Models 1 and 2 are a coarse and fine polyhedral approximation, while Model 3 is a graphical model, and the choice among these is dependent on the application, accuracy, amount of training data available, . . . . Model 4 is built from these models, as a set-theoretic expression (M4=((M1 Union M2) Intersection M3)), and points to another memory block (not shown). Each datablock can have a different choice. The additional models can improve exemplarily improve accuracy, speed, memory usage, and/or some combination of these and other properties. Simpler models can be used for analysis/optimization first, followed by more sophisticated models if needed. Lossless models like Lempel-Ziv compression can also be considered.

8.2. Linking Datapoints and as Dated Models

Ganaka's architecture maintains links between the atomic objects (datapoints) and associated models, and can use either or both for analysis/optimization. Each datapoint corresponds to one or more models, and two ways links are maintained between a datapoint and associated model(s).

These links can be explicit for high speed (e.g. pointers), or implicit for conserving memory, by a predefined layout of the memory system. With N datapoints and M<<N models (M is orders of magnitude smaller than N, and may not change even if N changes—FIG. 6), the number of explicit pointer links should be much less than N.

The number of datapoints N typically increases with time (unless old data is discarded), and the number of models M can also change with time, and the maps have to be dynamic.

As the number of datapoints N increases, the number of models may grow (generally very slowly). Models can be split into finer models, aggregated into coarser models, . . . , depending on the application needs and the growth in the number of datapoints N. The associated inference structures (I-structures) speeding up processing/reducing resources have to be accordingly updated.

A single datapoint can be associated with multiple models, and a single model does in general model multiple data points
The two-way mapping is designed to be fast, avoiding excessive resource overhead.
   In the direction from a datapoint to a model, the mapping can possibly be a hash, lower/higher order address bits, . . . /. A datapoint or block of datapoints can be associated with multiple models, on an application specific basis (FIG. 6).
   In the reverse direction, from a model to a datapoint/blocks of datapoints, we can store a start address, and end address, and a stride (or a list of them), or some similar easily computed and memory efficient, 1-Many mapping (FIG. 6). With a stride, of say K words, we can accommodate K different series of datapoints, . . . interleaved with each other
Some models need not have any datablocks associated with them,
Generally, but not always, models are derived by fitting to historical data. In some cases, they can be derived independently of historical data, from apriori system information (e.g. flow conservation constraints).

8.2.1. Multiple Models and Block Hierarchy

Models can refer to blocks, collections of blocks (typically but not exclusively a coarser model, . . . ), creating a model hierarchy. FIG. 7 shows a mixture of models, changing as the block size is changed the blocks can possibly overlap, and also be random subsets of the complete set of datapoints. The models can change to simpler polyhedra or more complex (maybe graphical) models, at each level of the hierarchy, depending on application. Ganaka's memory exemplarily maintains aforesaid two-way links between data blocks, aggregated data blocks, and their models.

As we get more and more data, we can choose the corresponding models to have a specific set theoretic and information theoretic relationship (models corresponding to adjacent blocks can intersect, . . . ).

8.3. Consistency Between Datapoints and Associated Model(s)

Models derived from data have to be kept consistent as new data arrives and/or old data is determined to be ignorable. Either new models can be created for the new data, or existing models updated.
In the case of model updates, we have
   For classifiers, the decision boundaries need to be updated at high speed (hyperplanes in the case of linear classifiers)
   For probabilistic models, the model weights (in Bayesian/MRF's) need to be updated, on arrival of new data.
   A fast trigger (interrupt/poll) to the software/hardware updating module is generated on arrival of new data, and performs the update. This module exemplarily runs on another core (FIG. 8).
The model(s), can vice versa, generate additional data, based on the arrival of datapoints. This could be of use, if the input data corresponds to infrequent samples of a datastream, and the model fills in representatives for the rest of the (unseen) samples. The model updater keeps the model up-to-date, using the samples of the datapoints it is given.
At all times, datapoints and models may not be consistent.
   Updates may not be completed in time before another batch of new data arrives.
   Autonomous changes to models may be made, based on updated apriori knowledge.
The device keeps track of how much data it has processed for each model (e.g. a start and end address, and a stride, for each model). It also keeps track of whether data is consistent with autonomous model changes mentioned above. Since data is voluminous, consistency information w.r.t autonomous model changes may be kept only at the granularity of a data block.
Inferences can be made with even models from partially analyzed data e.g. if a model from a full data series A is a subset of another model derived from a partial data series B, then it is a subset of the model derived from the full data series B, . . .

8.4. Ganaka ALU for Models (Interference Engine)

Models are sets, and basic operators deal with sets as the fundamental objects (but sets can be split when required, and the invention has mechanisms to handle this situation).

Both Set and Information Theoretic Operators can be speeded up using the structure above, and linear programming may not be required for even convex models. A few mathematical details:

8.4.1. Set Theoretic Operators
The union M12 (variable Z) of two models M1 (vector variable X1) and M2 (vector variable X2) can be specified as

Z=THETA1 X1+THETA2 X2,

with exactly one of THETA1/THETA2 being 1 and the other zero.
The convex hull of the union is also specified as (this is a linear program if M1 and M2 are polyhedral)

Z=THETA1 X1+THETA2 X2, 0<=THETA1, THETA2<=1; THETA1+THETA2=1
The cross product is given by Z=(X1, X2)
The arithmetic sum/difference/product can be defined similarly—

Z=X1+X2,X1−X2,X1*X2, . . .

Logical Operators on two models A and B can be computed by juxtaposing them:
   A and B are disjoint, if and only if the combined Indicator Function is zero everywhere.
   A model A is a subset of another B as if and only if every satisfying assignment of the variables for A, satisfies B also.

8.4.2, Information Theoretic Operators:

Considering information theoretic operators, the measure (volume) of a subset of the sample space, is the probability of the event associated with that subset. Fast inference techniques (LP/ILP, belief propagation, Monte Carlo Markov Chain, log-linear modeling, Gibbs Sampling . . . ) can be used to estimate this probability, and equivalently the measure associated with this subset. Based on the volume/measure/probability (which can be stored together with the model), equivalences between models can be defined. The volume is the Partition Function under a uniform distribution, and methods to evaluate Partition Functions can also be used.

8.5. Genaka's Inference Engine

FIG. 9 shows a general framework, where Ganaka's ALU, which is an inference engine (IE), is coupled to the memory. This inference engine can take any kind of model (linear, convex, general non-convex, continuous and discrete), as operands and facilitates analysis/optimization, by yielding set-theoretic, information theoretic, arithmetic, and other operators between the models, using a state-of-art algorithm (exemplarily listed above the algorithm will in general be updated/improved over time). The inference engine may include analog components to implement Boltzmann machines and their variants.
The inference engine handles 1-operand and 2-operand relations directly.
IE attempts to optimally schedule the computation of multiple relations between multiple operands using 1-structures (Section 10), and symmetry/transitivity properties.

The data model classes impose structure on the model (which may or may not be a polytope/convex body) representing a general dataset. Our earlier invention (Polytope and Convex Body Database) used only the support of the PDF, and assumed it is polyhedral this invention allows more general structure, with more operators, which are in general faster, and more memory/resource efficient. The description discusses primarily graphical models. But the use of the optimal methods, based on the structure of the polytope/model, are applicable to any model, and the claims extend to them.

At this point of time, technology to meaningfully bound the absolute resource usage (absolute time, memory, . . . ) of the inference algorithms in the IE is not available (other than if the models are convex). Hence it is expected that an appropriate architecture would support multiple algorithms, possibly in parallel and be able to quickly switch from one to the other, start/terminate certain algorithms, depending on progress. As such coherent memory, accessible by multiple threads may be required.

The lack of guaranteed resource limits implies that an operator may not be completed in a time/memory limit, and its output is then denoted as UNKNOWN in any further processing in the inference engine. In such a case partial state e.g. a tree partially searched in an ILP formulation—may be stored if required by the application. Convex approximations can be tried, whose time is better bounded than general operators, and the answers will be UPPER-LOWER/CONSERVATIVE-OPTIMISTIC bounds depending on the operator. Convex approximations (and all those which can be computed in guaranteed time), can be flagged as such in Ganaka's IE.

Ganaka's IE has the ability to use these fully and/or partially computed inferences, in its succeeding inferences, potentially applying Machine Learning methods. In an embodiment, the IE may include another module to periodically resume processing of these partially computed inferences, and storing the completed inferences, or updated partial state, for future use.

The resource usage of the operators (absolute/relative), cannot be easily bounded, and they sometimes produce unknown or upper/lower conservative/optimistic answers, if convex and similar approximations are used. Ganaka's Inference Engine organizes the use of these answers using techniques derived from general program verification. FIG. 38 shows an additional field (for node/model P1), where a pointer to a partially computed state/approximation to a relationship is stored if unknown answers/bounded answers are present. This pointer can refer to either a set-theoretic or an information theoretic relationship (or any other binary relationship) of P1 with any model. Convex approximations (and all those which can be computed in guaranteed time), can be flagged as such in the memory system, associated I-structure, . . . , and the operators run till completion for them.

The determination of which approximation/order to use for a specific operator, can be based on a machine learning technique.
The simplest approximation can be tried first, followed by successively more refined models. These approximate answers can be immediately communicated, for computing other operators and/or operand pairs.
Ganaka's IE (FIG. 12 Structure of Inference Engine and ALU in Ganaka) is an ML system, and uses approximations, transitivity and apriori properties, apriori structure, and operator scheduling, together with basic algorithms, to improve performance speed, memory, i/o, . . . .
   Approximations replace complex operands with simpler to analyze operands
   Transitivity and other properties are operator properties which simplify analysis
   Operator scheduling attempts to minimize work based on all the above.

In FIG. 12, Ganaka has facilities for high speed communication and interrupt facilities between the different modules shown. All modules may be in software, hardware, ASIC, RAM, . . . . Data is input, modelled, stored in RAM and/or disk, and operations on the models are performed. The models are derived using exemplarily machine learning techniques (polyhedra, Bayesian Models, Markov Random Fields, Deep Neural Networks (DNN) . . . ) F12_IE_300. 2-way links are made between the raw data (if stored described in Section 8.2), and models. Models are typically domain specific (video, audio, finance, . . . ), and can come from a decision support system. Summary models (described later) F12_MS_500 are also maintained. Operations (set theoretic, information theoretic, arithmetic, logical, . . . ) F12_OP_200 are performed using a combination of kernel algorithms, pre-stored results in the I-structure, and inferences based on operator properties like transitivity, associativity, . . . , and (possibly convex) approximations F12_APPROX_100. The choice amongst these can be under programmer control, and/or exemplarily machine learnt, and multiple approaches can be fired off in parallel on separate cores of a multi-core computer. Partial state/results can be stored, if the operation time/memory/other resource, exceeds an allowed maximum. Operation statistics are maintained to optimize time/other resource usage. FIG. 13 shows an exemplary flow of control for the IE, which is determined using the programming language interface F13_PL_900, and/or the controller in FIG. 12. In this figure, an 1-structure check is first made, and then approximations are tried, and only then the full heavyweight operator is exercised. If the resource exceeds a limit, then partial answers/state can be stored.

In essence, Ganaka learns the data model(s), and uses the data model(s) in conjunction with the datapoints, as far as possible. Ganaka's basic operator algorithms, are continuously updated with progress in the (and exemplarily kept in the microcode/nanocode/WCS). Ganaka utilizes properties of basic operators like transitivity, associativity, approximations, . . . to further improve performance. Results are cached in the I-structure. Ganaka can and typically does learn different models for different regions of dataspace. Some of the models may be based on apriori information, and not necessarily derived from data. The choice and scheduling of operators is exemplarily based on Machine Learning, in a supervised or unsupervised manner.

8.5.1. Learning and Inferencing in Bayesian Networks

Here we describe how the (sparse) structure of Bayesian networks computationally simplifies set/information theoretic operators in Ganaka. We show several examples.

An exemplary embodiment in FIG. 14, FIG. 15, and FIG. 16, above shows a Bayesian Network, and its associated (non-convex) polyhedron. In the Figure above y and z are conditionally independent given x. Hence in the y-z plane they satisfy one or more linear box constraint (s)

Y min(x, . . . )<=y<=Y max(x, . . . )

Z min(x, . . . )<=z<=Z max(x, . . . )

The support region is clearly a rectangle (or a set of rectangles arranged in a rectangular grid) in the y-z plane, whose dimensions depend on x and possibly other variables. Set and Information Theoretic operations on such an entity can be computed much faster than using general Mathematical Programming Techniques ignoring structure (FIG. 14, FIG. 15, FIG. 16).

FIG. 15 shows two polyhedra, whose set theoretic relations (intersection) can be computed using comparison of parameterized rectangles only (a general mathematical programming code is not required). Graphical models (which need not specify polyhedra in general) can be adjoined, and tested if the models can be jointly true or not. In FIG. 17 (a), models M1 and M2 intersect, iff the probability of node N being 1 is non-zero. In FIG. 17(b), if we prove that M1 implies M2 at node N, then the model M1 is a subset of model M2. Clearly this method extends to determining probabilities of jointly being true or not, and also probabilities of arbitrary logical expressions in First-Order-Logic and other logical systems.

Information theoretic operators can be also simplified. FIG. 16 shows two materializations 101 and 102, where the cross-sectional area (analytically computable for a hyper-rectangular region), is preserved in the y-z plane, at each value of x, and other relevant variables, preserving the total volume of the polyhedron, and by implication the information content.

The easily proved Lemma below further illustrates how Bayesian structure simplifies operator computation:

Lemma: A convex polyhedron specified by a single level Bayesian model (root directly connected to leaves—FIG. 18), has a cross-section which is a hypercube (or a rectangular grid of hypercubes), which increases/decreases only once, satisfying convexity. The cross section is a hypercube, since we take only the non-zero support of the PDF in the robust formulation.

The hypercube dimensions are dependent on the separator (conditioning) variable. The boundaries can be analytically characterized, given the rate of change of the dimensions, with the separator variable. Based on this hypercube cross section, instead of using linear programming (LP), we can use analytical methods to perform set theoretic/information theoretic operations (volume, . . . ).

The analytical characterization eliminates the need for general LP's to be used for set-theoretic operations.
At each value of the separator, only hypercube bounding boxes need to be compared (this does not require LP's, unlike the case for general polyhedra). The dimensions of the bounding box vary as a function of only the separator.
For a conditional independent set of K-variables, a K-dimensional hypercube with 2K faces results. The hypercube parameters can be analytically determined.

Similarly, the analytical calculation makes information theoretic operators computationally tractable (see FIG. 19)
The volume is the K-dimensional hypercube volume (product of the dimensions, each a known function of the separator variable), integrated over the values of the separator variable.
A1-dimensional integral over the values of the separator variable yields the multi-dimensional volume, given a Bayesian network with a single separator variable and K leaves (K conditionally independent variables).

V=∫ₛΠdₖ

The above can be generalized to an arbitrary Bayesian network. For a node with K-leaves, set theoretic operators need to deal with only 2K independent facets per polyhedron, with the facet being a function of the value of the node variable.

A general algorithm handles cases including the two models satisfying two Bayesian Networks is shown in FIG. 20:

The conditional independences, and shape of the support hypercube(s) are inferred from the graphical model.
In FIG. 20(a), y and z are independent given x, and w and k are independent, given z.
In FIG. 20(b), x and z are independent given y, and u and v are independent given x.

Optimal set and information theoretic operations can be done based on this structure.

8.5.2. Learning and Inferencing in Markov Random Fields

Alternative graphical models can also be used to simplify processing in the database. An exemplary embodiment showing a Markov Random Field, and associated volume computations is in FIG. 21. From the figure, we immediately get the multidimensional volume as:

Volume of the MRF=Volume of (x1,x2)*Volume of (y1,y2)/Volume of (A,B)—Ref Petitjean Equation 1

Materialization operators can be applied in (x1,x2), (y1,y2), or (AB), or even jointly, and the computations are faster, because of the reduced number of dimensions. Materializations need not be restricted to orthogonal transformations and their variants mentioned in our earlier patent applications but can be arbitrary volume preserving transforms.

Set theoretic operations can also be optimized. These operators can be applied in (x1,x2), (y1, y2) separately, since these are independent cliques. If there is intersection in either (x1, x2) or (y1, y2), then there is global intersection

Further simplifications are available for a Markov Random Field, with a decomposable model (chordal graph) as in FIG. 21.

Consider 2-operand operators.
With each operand satisfying a graphical model with a parent with K children, each with N/K nodes, a LP takes O((N/K)\hat{ }3) per pair, and an LP for the assemblage of 2-operands takes O(K\hat{ }2*(N/K)\hat{ }3)˜O(N/K) time total, if each and every pair of LP's has to be evaluated for a set-theoretic operator. However, all pairs need not be tested in general, and the following optimizations hold (in addition to Dantzig-Wolfe and other standard block structured LP optimizations).
   Disjoint Operator:
      Any Clique in Operand 1 disjoint from a Clique in Operand 2 implies that the polytopes are disjoint. The Cliques need not be over the same variables in both operands.
   Intersection Operator:
      If each pair of cliques intersect, then the two models intersect.
   Subset Operator:
      Each and every Clique in Operand 1 has to be a subset of the corresponding clique in Operand 2.

### 9. EXEMPLARY GANAKA EMBODIMENT AS A COMPUTER SYSTEM

An exemplary embodiment of Ganaka is described below, but the claims refer to all variants covered by the general ideas (there are other embodiments which can be developed on the same lines). The extensions to the state-of-art in this embodiment includes:
A highly compressed and generalized representation of point data using multiple models.
A new ALU operating on models, the inference engine, specifically implementing set-theoretic and information-theoretic operations at high speed using
   A (microcode/nanocode/WCS (writeable-control-store) implemented exemplarily in an EEPROM/ . . . ) downloading the latest algorithms from an external instruction memory. This microcode/nanocode/WCS is low latency, and simplifies the ALU datapath, since hazards and interlocks, and Instruction-Level-Parallelism detection are considerably easier.
   A software-hardware complex, the I-structure (inference-structure), comprising a directed and/or undirected graph, storing precomputed relations, with transitive links optionally removed. Accessing the I-structure yields orders of magnitude speedup. The I-structure is unique to Ganaka's usage of models, and does not appear in standard computers processing point data.
   Coupling the I-structure with the memory hierarchy, at the register-file, L1, L2, . . . levels.
A memory manager which offers facilities to compress/expand memory usage, by merging/splitting/convexification of models (or equivalent operations). This facility of changing models, is also unique to Ganaka, and is present only because of the usage and representation of aggregates as fundamental entities.
Merging and Splitting models, implies corresponding changes in the I-structure, and the memory manager has hence to communicate with the Inference Engine. The inference engine, also may initiate changes, by requesting the memory manager to (exemplarily), merge models which predominantly appear as a union in Ganaka's expanded instruction stream, or are in the middle of a subset chain which is accessed predominantly at the topmost superset (root).

All these facilities can be used under either or both of in-built automatic, and programmer driven control.

1.1. Model Specification in Memory

First, all models are pointers to locations in memory (16-bit, 32-bit, 64-bit, . . . ) holding their constraints, bounds, conditional probability distributions (for Bayesian models), topology (for Bayesian networks, DNNs), . . . . The models are of different kinds, ranging from single datapoints, to bounds, to complex DNN's. As such their memory usage varies widely, from a few bytes for datapoints, to 100's of megabytes of DNNs like VGG16. The usage of the address space as model names is expected to be sparse (at least for 32/64 bit pointers), since we have far fewer models compared to datapoints.

For high speed operation, the memory location pointer has to be translated to a model number and vice versa. The model number (assumed sequentially from 0, 1, 2, . . . ) to pointer is a table lookup. The reverse (pointer to model number), can be implemented using a CAM, a cache, or can be simply part of the model record in memory.

In all the subsequent discussions, models will be referred to by their model number, but the two-way implicit translation above should always be understood.

FIG. 23 shows a typical model layout in memory, for models M1, M2, M3, . . . . The Model Type structure F23_MT_100 describes the type of the model, whether it is structured, polyhedral, graphical, . . . , whether it is a subset/superset/ . . . , whether it is discrete/continuous, Some points may not be in the model, and pointers to these “outliers” are also stored here or in datablock F23_DPT_200. Model parameters F23_MP_300 are stored, along with a pointer to the operator code packages handling such models F23_OC_400 (these range from direct calculation for datapoints, interior point/SIMPLEX for LPs, to MCMC type algorithms for graphical models). Modules F23_MT_100, F23_DPT_200, F23_MP_300, may exemplarily be in data memory, and modules F23_OC_400 and the code packages referred to, in a special microcode/nanocode/WCS (writeable instruction store), in Instruction Memory. The data and instruction memory may be combined also.

Global facilities like model machine learning packages, special form constraints (e.g. a substitutive/complementary constraint with all unity coefficients, . . . ), forming a constraint pool F23_CP_100), . . . , namespace translation F23_NP_100 are shared by all models M1, M2, M3, . . . . So is a memory manager F23_MM_100, which manages multiple memory areas.

Each model has a field pointing to the code blocks implementing its operators. For the finest models (datapoints), processing is done by a conventional ALU (which may be combined into the Ganaka ALU). For intervals, an interval arithmetic processor can be used. A linear programming engine is used for convex models, and a general graphical model/DNN package for complex models.

TABLE 1
Size of various kinds of Models

| | | No of | | |
|---|---|---|---|---|
| Model | | Parameters | | |
| Type | Equation | (N dimensions) | Storage | N = 100 |
| Bounding | Xmin <= | 2N | 2N | 200 words |
| Box | X <= Xmax | | words | [8K bytes |
| | | | | @32-bit float] |
| Polyhedral | AX <= b | M (N + 1) | M rows, | 0.4K |
| | | A: M × N | (N + 1) | bytes@32-bit |
| | | | words | float per row |
| Graphical | Adjacency | N * #Nodes * | Adjacency | 10's MB |
| | Matrix, CPDF | #CPDFpts | list with | |
| | | | pointers | |
| DNN | Adjacency | N * #Edges | Adjacency | 10's MB |
| 1. | Matrix, | | List with | |
| | Neuron, | | pointers | |
| | Weights | | | |
| . . . | | | | |

Table 1 lists exemplary sizes of models, assuming no compression and standard memory layout. Matrix are laid out in standard (sparse) matrix order as a 2D array or a linked list. CPDF's in graphical models are laid out as arrays conditioned by the ancestor parameters.

For 100-dimensional data, bounding box models are small enough to fit even a high speed register bank, polyhedral models with 100 constraints will fit inside a high speed 64K cache, while the other models will reside in slower memory. Where possible, convex polyhedral models are preferred.

Some exemplary memory layout diagrams, and links between datapoints and associated (multiple models) are shown in the three figures below:

Given the models described above, an exemplary embodiment of the Ganaka's IE and related portions is given below.

1.1. The Memory Manager, and IO Manager,

FIG. 24 shows details of this embodiment of Ganaka. The IE can be a co-processor to a conventional ALU, integrated with a conventional ALU, or a hybrid with partial integration. Interconnect between the IE and the conventional ALU is as per state-of-the-art.

FIG. 24 shows the exemplary Ganaka embodiment as a computer System. A conventional ALU /Memory/IO system may co-exist, but is not shown for clarity. This may be merged or separate from IE/IE Memory Map/IE IO map. It may share the same address space, as in CAPI from IBM. There may be seamless co-operation with a conventional ALU (source/object compatible).

The microcode/nanocode/WCS/FPGA/ . . . F24_uC_100 controls the operation of the IE (inference engine). It accesses data in the form of models, in model memory F24_MOM_100, instructions to perform basic operation on models in the microcode/nanocode/WCS, and a temporary “scratchpad” memory F24_SM_100, for intermediate results (e.g. search trees). Especially important is the 1-structure F24_IS_100 which enables bypassing calculations entirely, when it can be inferred directly. All these memories are orders of magnitude smaller than the raw data being modeled. The size of the scratchpad memory can be significant depending on model complexity, but is independent of raw data size. The I-structure F24_IS_100 (and F25_HIS_100), can be small enough to fit in L1/L2 cache (F25_L1_100/F25_L2_100), and for small number of models, it will fit in the register bank itself (F25_RF_100) FIG. 25).

1.1. Control Flow

The microcode/nanocode/WCS (F24_uC_100 in FIG. 24) controls by default a small, shallow pipelined ALU, with exemplarily simplistic versions of modern superscalar technology (Hazard detection, OO-E, . . . ). The address space for the constraints is small
With 16-bits (respectively 32 bits) of address space, we can easily accommodate a 100×100 dense matrix (respectively 10,000×10,000 dense matrix), which translates to storage of 100's of models with 100 parameters each (respectively 10,000 models with 10,000 parameters each), sufficient for many applications.

There are exceptions, however. Operations on general non-convex models involving search (e.g. ILP models, graphical models, DNN's), may require extensive temporary scratchpad memory. However, this complexity does not scale with the number of datapoints driving the model, but rather the complexity of the model (e.g. number of model constraints, sparsity/density of the constraint matrix, . . . ).
For simple models, a small low latency high throughput memory would be sufficient.
For complex models, a larger amount of memory, with higher latency, may have to be accessed.

In FIG. 24 (also FIG. 25), the microcode/nanocode/WCS F24_uC_100, for each model type, does the required ALU-memory pipeline scheduling.

1.2. I-Structures (Inference-Structures)

Set and information theoretic operators are heavyweight, and should be stored once computed, in an I-structure (inference-structure)
The I-structure is unique to Ganaka, because we deal with aqqreqates. In conventional ALU's handling atomic data, we just have equality/inequality comparison there is no change of shape, volume measure . . . . The management of I-structures, and interface to the ALU In the IE, is sophisticated, and is part of the invention.

The I-structure is in its simplest instantiation a 2-D array for each relationship (and this can be compressed for transitive operations, as described below), with a special value NULL if the relationship has not been computed so far (the relationships are heavyweight, and every relationship cannot be apriori computed). Alternatively, it can be a linked list, as is well known in the state-of-art of storing binary relations in matrices.

1.3. Exemplary Ganaka Operation: Subset

An exemplary operation of this embodiment of Ganaka is as follows (other operations can be inferred by those familiar with the state-of-art). Consider a two operand set-theoretic instruction
MA=isSubset(MB, MC); // MA is a Boolean variable indicating if model MB is a subset of model MC

The isSubset( . . . ) operation points to a block of memory code (exemplarily in the Writeable-Control-Store) implementing the operation.

### Step 1:

Since the basic models are heavyweight, we first check in the I-structure if the operation has already been performed, or can be inferred. For high speed, the I-structure itself should be a small piece of memory even in the register-bank, with just 100's of registers.

### Step 2:

If step 1 fails, and the I-structure does not contain the result, then the model operation code is executed.

An exemplary pseudo-code is below

```
MA=isSubset(MB, MC);
If (MA=I-structure(MB, MC) == NULL) {
  MA= isSubset(MB,MC);
  //heavyweight operation exemplarily in microcode/nanocode/WCS//
  I-structure(MB,MC)=MA; //store for future use
}
Compress(I-structure);
//eliminate transitive links and store frequently used transitive links in a hash table
Return (MA);
```

The compress(I-structure) operation removes transitive links, and if required, saves some of them in a high speed hash table/cache. This is a large savings, from O(\hat{ }2) to O(N), e.g. a full I-structure for 10000 models involves 100 million entries, and will not fit in cache, but one where transitive links are removed, has only 10,000 entries, and may fit in L1 (at most L2) cache. If we have only 100 models, a compressed I-structure needs only 100 entries, and can fit in the register file, enabling a very shallow ALU pipeline without the need to tolerate large memory latency.

If transitive links are removed, and the I-structure is a linked list then iterated pointer chasing exemplarily locked in the microcode/nanocode/WCS/FPGA/ . . . is required (the 2-D table lookup is not possible). The iterated pointer chasing needed is a special instruction exemplarily locked into the microcode/nanocode/WCS, since it is ubiquitously used in Ganaka. The pseudo code for isSubset(MB,MC) is shown below (for a DAG, a cyclic I-structure implies equality, and nodes can be collapsed into one):

```
isSubset(MB, MC):
MP= MB;
Repeat until MP= NULL;
For each ((MP1=parent(MP) and !visited MP1))
  If (MP1 == MC)
    break;
  MP = MP1;
  Mark MP1 as visited
end
if (MP == MC)
  return TRUE
else
  return FALSE.
```

If the I-structure lookup fails, then the microcode/nanocode/WCS/FPGA/ . . . controller invokes the typically complex operator program (loaded from disk/RAM into the microcode/nanocode/WCS). If the complete operator program does not fit in the microcode/nanocode/WCS, frequently used kernels can be loaded, and the rest directly executed from RAM.

Frequently used Instruction kernels can be identified by programmer and/or a machine learning controller (ML controller). In the case of the ML controller, we need some apriori information about the boundaries of instruction kernels, else “half a loop” can be loaded, if there is not enough memory to accommodate all kernels. Exemplarily, code for matrix-vector/matrix-matrix products can be loaded.

1.4. Memory Management

The memory manager includes all the conventional features of memory management in contemporary computers.

In addition, it has the new and unique ability to change old models to new models (model mutation), for improving accuracy using more sophisticated models, speed using simpler ones, reducing storage/io, etc. . . . . The memory manager may be part of Ganaka, the conventional ALU, the operating system, . . . , as is known in the state-of-art. The facilities include the ones described below, but are not restricted to them:

### Reduction of I-Structure Memory.

If the I-structure is kept without transitive links, it is of size O(N) and is kept in high speed memory. A full I-structure, with O(N\hat{ }2) links, is kept in larger memory.
   Ganaka periodically cleans up the I-structure by compressing it by eliminating transitive links, and in general remove any link which is inferable (e.g. a superset of A which interests with B, intersects with B, a subset of A disjoint from B, is disjoint from B, . . . )
   Ganaka stores frequently used transitive links (in general inferable links) in a special I-structure cache, which may be exemplarily co-located with other structures in model and/or scratch-pad memory.

### Reduction of Scratch-Pad Memory

Ganaka uses precomputed structure driven computations as much as possible (especially in Decision Support Systems, where algebraic expressions are used to define models e.g polytope P1=P2 and P3), to eliminate the large overhead of scratchpad memory.
This also speeds up microcode/nanocode/WCS computation
Ganaka uses materialization to get rectangular information equivalent box constraints, and reduce scratch-pad memory overhead.
   This also speeds up microcode/nanocode/WCS computation.
Use regular models to reduce both memory and time.

### Reduction of Model Memory Overhead

A single model in Ganaka can using orthogonalization transformations, and generate many equivalent models—the code for this transformation can be in microcode/nanocode/WCS.
Ganaka can, using convexification of models create simpler models.
   This also speeds up microcode/nanocode/WCS computation.

1.5. Garbage Collection:

Garbage collection and memory reuse is a fundamental operation in memory management. In Ganaka, space may be reclaimed in model memory, in microcode/nanocode/WCS instruction memory, and/or scratchpad memory space.

FIG. 26 shows an example of the operation of the garbage collector. To avoid the figure from being cluttered, we drop the prefix F26_xx_ in this paragraph, but the entity being referred to should be clear. First, two memory blocks A and B (which may or may not overlap) containing D-dimensional data, are modeled using the same convex polytope M1. Then, a graphical model M2 is added to one of the memory blocks, to improve performance. Finally, as the space reduces, the graphical model can be discarded (c), or merged with the polyhedral model, creating the convex hull of the union of both (d). The convex hull has typically many facets (exponential in D), and a rectangular “box” model with the same volume can be created with 2D facets, and computationally easier to handle, and storage efficient, compared to the convex hull (e). Other means of simplification include dropping constraints, . . . . Algorithms to perform these operations are known in the state-of-art.

All these models have different sizes, as Table 1 exemplarily indicates, and Model memory does potentially gets fragmented, which is handled using methods known in the state-of-art, except for models updates as given below
The garbage collector controller decides when to do model updates, and which models to update. This depends on the usage pattern of the model, the space available in memory, . . . . It may be in another microcode/nanocode/WCS, or just in Instruction memory, if infrequently applied. Corresponding updates to the I-Structure have to be made, if any of these models has been included there.
   The evaluation of which models to update depends partly on the usage pattern and complexity of the model. A very complex model will be less preferred to be updated, if heavyweight relational operators have been computed on it already. If model memory limitations require it to be updated, then it can be reallocated to lower speed higher capacity memory (e.g. RAM).

The merging/splitting is based on the priority of the models, and involves interacting with the Inference Engine/I-structure through exemplarily a dedicated bus. An exemplary priority has the following characteristics (similar to a generalization of LRU in caches).
1. Models heavily used are assigned low priority. In other words, models A, B, and C, and C is frequently used (in queries, . . . —this can be checked in the I-structure), changes to C should be prioritized lower, with an priority decrement—dP1.
2. In addition to usage, the memory manager will evaluate the complexity of the model. For complex models, if heavyweight relational algebra operators have been evaluated for it, deletion or changes to the model have to be prioritized lower, with an priority decrement—dP2.
3. If, in the Ganaka's instruction stream, two models occur primarily in (say) union, then they can be merged with an priority increment dP3, . . . .

The overall priority of changing a model (the change is assumed to be merging with another) is then exemplarily

Ptotal=Pbase−dP1−dP2+dP3

where Pbase is the priority of total priority of changing any one of the models in model memory (depends on the space available for model memory). Of course a nonlinear combination can be used of all the aspects affecting model changes (merge, splits, model simplifications, model detailing, . . . )

In Section 10, an example of the benefit of merging models is given, where the memory reduction is 35%.

### 10. MEMORY AS AN EMBODIMENT

The memory in Ganaka, automatically or through the programming interface, derives data models, depending on the application (compression achieved is lossy and/or lossless). This memory device can be organized as a database also, and such an embodiment is described later. We also note that exactly analogous methods can be used for input-output facilities in Ganaka also.

In one embodiment, compression is lossy, as in those places where appropriate, models are used in conjunction with original data. The lossy compression is acceptable in several applications, e.g. in statistical application where only data averages have to be preserved, optimization over uncertainty, . . . , since data available is only a predictor of the future. Models occupy much less storage compared to original data, processing time and power/energy can be reduced, and resources in general used more efficiently.

FIG. 27 shows a compressive memory, where certain pairs (x1,y1) are approximated as points inside a polytope (or another region, e.g. a region specified by a graphical model).
The RED bold region is approximated by a convex polytope,

−0.5<=x1<=2.5

Y1=−x1
The BLUE italics are approximated by a non-convex graphical model, with X1 being restricted to the five values 1.1, 1.2, 1.4, 1.5, and 2.2.
Three values (1,2), (3, 0.1) and (3.3, 0.5) are left as is.

Instead of 16 2-Dimensional points, we have 3 2-Dimensional points and 4-constraints.
The first constraint −0.5<=x1<=2.5 specifies bound [0.5, 2.5] on x1, and is equivalent to a single 2-D point (with an additional flag differentiating between a point and a bound).
The second one can be written as −x1+v1=0, equivalently [−1,1], [x1,y1], and this is also equivalent to a single 2-D point. “.” Refers to a dot-product, also indicated by the flag above.
The third constraint X1 in {1.1, 1.2, 1.4, 1.5, 2.2}, can be represented in 3 2-D point pairs.
The fourth constraint X1+0.8<=Y1<=x1+1 is equivalent to two constraints

x1−y1<=−0.8

x1·y1>=−1.0
and can be specified with 3 numbers for each constraint 3 pairs in all.

We have 17 2-D datapoints in the original data. The models need 3 2-D points, plus 4 constraints, equivalent to 8 2-D points equivalents, totally 11 2-D points, a storage reduction of 35% compared to the original datapoints. This reduction grows without limit, as more points arrive in the modelled regions—a technical improvement. If the data stored in the memory is regarded as tuples of a database, we can use the prior art in our patent and patent applications PCT/398, and “Polytope and Convex Body Database”, and succeeding applications, . . . to do high speed relational algebra. Of course both the original datapoints and the models can be stored, and used in conjunction. The overhead of models, is as illustrated, relatively small.

Convexified and other approximations of general models, e.g. Bayesian Models/Markov Random Fields can also be used, e.g, instead of the constraint:
X1 in {1.1, 1.2, 1.4, 1.5, 2.2}

We can use the convexified relaxation (which also yields data compression)
1.1<=x1<=2.2

10.1.1. Facilities Offered as a Memory Device

Based on the discussion above, and elsewhere in this document, the enhanced memory device offers the following facilities:
Estimation and storage of models from datapoints, and/or apriori information, in an application specific manner, e.g. estimation of polytopes as per our earlier description, and patent/patent applications (and the description of Ganaka in Sections 8 and 9, from either or both of the perspectives below:
   The underlying model is treated as “truth”, and datapoints as model evidence.
   The truth is the data samples, and models can be exemplarily used to reduce storage and/or speedup queries.
      The number of models can be increased for higher accuracy of reproduction of original data.
   The number of models can be chosen to fit the data into the available space, by splitting and/or merging and/or using convex approximations of polytopes and/or other models.
Models can be used to generate new data expanding/compressing original data.
   The compression obtained is application dependent, and different portions of the memory can use different models.
When the memory is configured as a eCmdB database, (with additional features as described below, extending the state-of-art and our preceding patents and patent applications)
   Models can be used to do set theoretic relational algebra, with applications to
      Supply chains and logistics, including Railways (conflicting trains, mergeable trains, . . . )
      Health Care (confusable diseases, . . . )
      Signature analysis/IOT
      Finance
      Weather
If the eCMdB is front ended by a nonlinear transform, generating features corresponding the a given class (e.g. a multi-layer neural network—FIG. 28 Error! Reference source not found.):
   If the transformation is directly invertible, we can generate samples in the original data space, corresponding to a given class, by generating samples in the features space and inverting the transformation.
      inversion is unique for a sigmoidal transformation with a single input
      Inverting to multiple inputs offers additional choices—a splitting policy hos to be chosen. One such is an output->multiple input, equal splitting policy (e.g. equally split output after inversion, to all inputs).
   If the transformation is not directly invertible, we can generate trail samples in the original data space, and check the features for validity according to the model.

10.1.2. Garbage Collection and Reuse of Memory

In addition to standard garbage collection algorithms, we have the additional facility of replacing one or more models with simpler models, taking less storage (e.g. a convexified approximation of the models). This has been described in detail in Section 9 (embodiment as a computer system).

MATERIAL TILL END OF THIS SUBSECTION (till 10: “A Database Embodiment”) MAY BE DELETED IN COMPLETE SPECIFICATION

Two polyhedral models in FIG. 25 are depicted as staying invariant, and two have been replaced by graphical models in FIG. 26. FIG. 26 additionally has one more graphical models, which may model portions of the same data as before (two polyhedrons replaced by graphical models), or model an entirely new portion.

This can be extended for non-convex polyhedra also.

Other operators can also be defined for graphical models, e.g.
Adding two models—Union of the sets (OR)
Subtraction of one model from another—XOR
Multiplication—take the outer product of the two models

As another example, FIG. 28 shows a 3-variable graphical model.
(a) (y,z) are independent given x
(b) (x,z) are independent given y

Instead of linear programming, we can just compare the intersection of squares, scanning over the domains of the respective third variable.

Models with Information Content

### 9. A DATABASE EMBODIMENT

When Ganaka's memory system is used as a database, we refer to it as an enhanced CMdB (eCMdB) an enhanced Convex Model database. Our earlier patented CmdB was restricted to convex models, and did not discuss operator scheduling for building I-structures, . . . . This enhanced database maintains possibly definitions for multiple data model classes. One or more classes can refer to a single database tuple or multiple-tuples. In addition, for query optimization, 1-structures are maintained, as per the facilities offered by the memory device.

As a consequence, the invention offers the facilities of a CmdB as per our earlier patents and patent applications, enhanced by the additional facilities offered by the special and general models, together with fast and memory efficient operators on them, nonlinear transformations, operator scheduling to exemplarily build-I-structures, data summarization, etc.

9.1. Namespace Management

Additionally, the invention incorporates a namespace manager (based on the same concepts as register-renaming), which manages mappings between variable names in a given namespace or multiple namespaces, is also present. The mapping may be 1-1 equivalences between a variable, say x, in one namespace, and another variable y, in another namespace. Similarly, it may be Many-1, 1-Many, or Many-Many. The namespace manager enables polytopes to be stored in a canonical internal form, and reused for all applications requiring such polytopes, independent of the variable names (in general namespace) used in the respective application.
Queries can optionally invoke or exclude namespace translations, as per the discussion below

FIG. 35 “Ganaka as a database, with Nonlinear feature extraction coupled to raw data, and producing outputs” shows a database engine based on Ganaka, described in FIG. 12 and FIG. 13, adding database operators, SELECT, JOIN, . . . .

A modeling module (F31_MM_100), which expands on FIG. 12 and FIG. 13, includes a nonlinear feature extractor producing outputs, whose polyhedral clusters form classes. Classes can also be derived from data models (Regular Polyhedra, Simplices, Bayesian Networks, Markov random fields). Class summary polytopes are also derived by the enhanced CMdB. SEVERAL PARTS ARE NOT SHOWN FOR CLARITY (I-structure Build-Update-Memory Compress Optimizer, Summarizer),

9.2. Database Facilities

FIG. 31, engine based on the computer system presented in FIG. 12 and FIG. 133 Exemplary Operation of IE in Ganaka”, depicts some of the facilities offered by this database, including the modeling module which includes nonlinear transformations to obtain features, algorithms to extract features (SVM, Neural Networks), Linear Classifiers (LP, German Tank), I-structures, multiple data model classes, including graphical models, inference engines beyond linear and integer linear programming, and summaries of the data. A namespace manager is also shown. All interactions between these are not depicted for clarity. The CmdB interacts with embodiments like the constraint manager, described in our prior work in Decision Support Systems (e.g patent 8620729/PCT/IN2006/000239, PCT/IN2009/000398, and co-pending applications and patents . . . ).

Raw data is obtained, the variables optionally translated by a namespace manager to other variables, as in the state-of-art in namespace management. This optionally translated data is then mapped possibly nonlinearly to a modeler as described in FIG. 12 and FIG. 13, which may have LP, Generalized German tank, or Statistical Machine Learning models like Bayesian Networks, Markov Random Fields, . . . (working on either the raw translated data, or the translated data after nonlinear transformations). These are stored as graphs and/or polytopes in the enhanced CMdB in a variety of manners incidence matrices, edge linked lists, constraint strings (for polytopes), . . . . Convex summaries are generated of these models, and possibly stored in the same CMdB itself. The general inference engine extends the LP and ILP methods used in our earlier patent applications, to non-convex models, including graphical models. I-structures as per our previous patent and patent-applications, with optimizing extensions, are created and maintained to speed up query handling.

Essentially all the features of Ganaka are available and used in this database embodiment.

MATERIAL TILL END OF THIS SUBSECTION (till 11: “Performance Optimization”) MAY BE DELETED IN COMPLETE SPECIFICATION

FIG. 32 shows details of graphical models. We show models referring to a single CMdB row (i.e. a single tuple), as well as models which refer to multiple rows in the CMdB. The model type and parameters can differ for each tuple.
The models can be combined with additional linear/non-linear constraints exemplarily specified in textual form, as per the state-of-art of the CMdB.
Multiple models can be combined with each other, to define the tuple for a row or a set of rows.
Each row can be exemplarily stored in a contiguous block of memory.

The graphical models can be interpreted apriori to yield exemplarily linear constraints, or can be used as is, without conversion to (linear) constraints.

### 10. PERFORMANCE OPTIMIZATIONS IN GANAKA: I-STRUCTURES

Ganaka's models are sets, and an important relationship between models is a set-theoretic relationship. The non-zero measure (i.e. volume, number of items in the collection) of models, leads to information theoretic operators on models.

As per our earlier patents and patent applications (treating databases), pre-computed relationships are stored in an I-structure (Inference-structure—essentially a cache for previous results). This application extends I-structures to general models and general relationships, and partial/fully computed results (where pointers to state are stored). An I-structure can be stored as a standard graph, with annotated nodes and edges, but transitive edges can be omitted for subset relationships, since they can be inferred. In general, for the set-theoretic relationships of subset, disjoint/intersection between nodes (corresponding to models) A and B, we have a directed edge from A to B (if A is a subset of B), or an undirected edge between A and B (for disjoint/intersecting). Information equivalences between two models A and B are represented by an undirected edge.
In addition to utility in the entire computer system, the I-structure can be used for any embodiment involving models, e.g. as a memory device, facilitating high-speed inferencing of set-theoretic and information theoretic relationship between models stored in memory. Similarly an embodiment as a i/o device, communicating with models in addition to point data.
It is equally applicable for fast inferencing of global relations among N sets, for any partially ordered relation between two sets.

In FIG. 33, P1 is a node corresponding to a model P1 (F33_MO_100), which may be a polytope, a regular solid, a graphical model, or something else. P1 is a subset of Q1 (F33_MO_200), which is in turn a subset of R1 (F33_MO_300). P1 is also a subset of W1 (F33_MO_400), Q1 (F33_MO_200) and W1 (F33_MO_400) intersect, but neither is a subset of the other (from this it can be inferred that R1 and W1 intersect). These links can be maintained in memory/disk, as logical or physical addresses, offsets, hash-tables accessed by the pair of models. As the operators are computationally expensive (especially information theoretic operators, even for structured models) all links need not be calculated/inferred apriori, but only when needed. Alternatively, in the case of a dense I-structure, an adjacency matrix representation can be used for these relationships. For large I-structures, compressed representations can be used also.

For each node, the information content (equivalent to the volume/measure), is also shown this may be maintained in the 1-structure itself, or elsewhere.

The memory usage of the links depends on the address-space of the machine and/or the total number of nodes/edges in the 1-structure. Each field can be 8-bytes (64-bits) in a 64-bit architecture. The Boolean fields can be packed into bytes, . . . , as per the state-of-art in memory compaction.

The resource usage of the operators (absolute/relative), cannot be easily bounded, and they sometimes produce unknown or upper/lower conservative/optimistic answers, if convex and similar approximations are used. Ganaka's Inference Engine organizes the use of these answers using techniques derived from general program verification. FIG. 34 shows an additional field (for node/model P1 (F34_MO_100)), where a pointer to a partially computed state/approximation to a relationship is stored (F34_PC_100) if unknown answers/bounded answers are present. This pointer (F34_PC_100) can refer to either a set-theoretic or an information theoretic relationship (or any other binary relationship) of P1 (F34_MO_100) with any model. Convex approximations (and all those which can be computed in guaranteed time), can be flagged as such in the memory system, associated I-structure, . . . , and the operators run till completion for them.

10.1. I-Structure Build Phase Optimization

The build phase of the I-structures can be optimized to reduce the number of heavyweight operations, and storage,

This is a technical improvement, reducing the processing time, power, and storage needs.

Essentially, we try to maximize the length of nodes (polytopes) in a subset chain, by cleverly choosing which links to evaluate first. This is a decision theory problem, where we need to decide which relationships to evaluate in the next step(s), based on the existing and inferable relationships. For example, if we have
1. Two subset chains of length N/2 each, we can check if the top of one is a subset of the bottom of the other, thus creating a chain of N polytopes, with just N heavyweight operations. N\hat{ }2−N heavyweight relationships can be directly inferred from these existing links.
   a. If either top is not a subset of the other bottom, then if the conjunction of the two is a totally ordered chain, we can use the binary chop method to determine where a node in one chain fits in the other.
2. For the same two subset chains, if we check that the root nodes of each are disjoint, then the entire chains are disjoint.
3. If the leaf nodes are intersecting, the entire chain intersects.
4. If two nodes have a common node as a subset, then they necessarily intersect.
These inferences yield a clue to optimal ordering of node operator evaluation. We guess the next pair to check and evaluate it.

In the general case, an I-structure is a forest of DAGs. We choose a link based on its assessed value (a function of the current transitivity, time of last use, . . . ), evaluate it using linear programming/graphical methods, and infer all the relationships possible after evaluating it, and repeat the process till there are no inferable edges.

FIG. 36 shows an I-structure as a DAG of 8 nodes. Each node represents a convex polytope and each directed edge represents a subset relationship. The node at the head of the arrow is a subset of the node at its tail. Any node x that has a directed path from another node y is also a subset of node x (transitivity). We can arrive at this DAG from different orderings. Consider two differing orderings, starting from no edges, shown in FIG. 37 and FIG. 38.

Ordering 1 shown in FIG. 37 shows 8 stages in building the I-structure. Orange nodes in each step indicate the next two nodes for which the relationship is computed. Within 7 steps, we can infer relationships between any two pair of nodes (56 relationships) for ordering 1.

Ordering 2 in FIG. 38 shows 8 stages of building the same I-structure but the choice of nodes for each step is different from ordering 1. The first 8 stages in building the I-structure are shown. Transitive edges, indicated with dotted black arrows in the first step that they are observed in, are not shown in the subsequent steps. Within 7 steps, only 18 relationships can be inferred for the sequence of node selections in ordering 2. A greater number of heavy weight operations are required to build the complete I-structure than ordering 1. This is because nodes with transitive edges are chosen first in ordering 2. For example, the first step chooses nodes 1 and 8 which is the longest transitive edge in the I-structure.

10:2. I-Structure Updates

During data updates, or due to changes in the memory allocated, the I-structures may change, as per the rules briefly outlined below.
If a new data point arrives, or the available memory space changes, the I-structure nodes (representing polytopes/other types of models) may split/merge/remain intact, depending on whether the new points lie within the nodes in the memory.
   If two nodes corresponding to models A and B merge to form another node representing model C (which includes all datapoints in the UNION of A and B, but may include more datapoints also, in a coarser model)
      All nodes intersecting with either A or B, are intersecting with C.
      Subsets of either A or B are subsets of C
      Disjoints from both A and B need not be disjoint from C.
   If a node corresponding to model C splits into two nodes corresponding to models A and B, which together include all the datapoints in C
      Nodes disjoint from C are disjoint from both A and B
      Subsets of C need not be subsets of either A or B
      Nodes intersecting with C need not do so with either A or B, but have to intersect at least one of them.

These rules, and analogous ones for multiple splits/merges of nodes, are used to keep the I-structure updated to reflect new data, memory allocation changes, . . . .

10.3. I-Structure Memory Optimization

The I-structure itself takes large amounts of memory, in big-data systems. A terabyte class memory system/database, with a polytope/other model derived from a million datapoints, will have a million polytopes/other models. An O(N²) sized I-structure would occupy about a Terabyte, which is clearly impractical to store in main memory/cache.

Methods analogous to cache replacement are available in Ganaka to conserve the memory required for the I-structure. Infrequently used edges can be removed, with the caveat that transitive edges which can be inferred from others, should be preferably removed first. The edges of lowest value (min number of transitive relations implied, and infrequently used), are the first choices to replace. Specifically:
Considering a set-theoretic I-structure, a 3-bit flag can identify whether it is a transitive edge, and whether it is a subset relation, a disjoint, or an intersecting relation.
We drop edges of low value, where value is a function of transitivity (only for transitive relations like subsets, information comparisons), time of last use, . . . . Transitivity is defined as the number of transitive inferences possible—edges which yield more transitive inferences are more valuable. The edge is deemed used both if the corresponding relation is explicitly accessed, or implicitly accessed through transitive inferencing (in a subset or other chain). However, since the exact value is unknown unless all O(N²) edges are computed, we use an approximation. This is a generalization of LRU, where the value is inversely related to the time since the last use of an address.

Edge Value=Function(Transitivity,Time since last use, . . . )
The function can be exemplarily a weighted arithmetic and/or geometric average. The existing edges are maintained in sorted order, and the least valuable edges dropped first ties can be resolved in several ways.

However, in addition to analogues of vanilla cache replacement policies, programmatic control is provided in Ganaka to schedule the building and updating of the I-structure.

Material till 11.4 may be deleted in complete specification.

FIG. 39 shows the value (cost/benefit) for the last used field calculated by an ALU as a function of time of last use, transitivity of edges (transitivity is defined as the number of transitive inferences possible—edges which yield more transitive inferences are more valuable). The sizes shown are exemplary. This is a method similar to cache replacement, allowing optimization of memory required for the I-structure.

10.4. I-Structure Optimized Build-Update-Memory Compress Algorithm

A fast algorithm to build-update-optimize an I-structure is given below. The programming interface enables customization of the builds, updates, and memory/i-o optimization of the I-structure.

We first perform all constraint text based and similar inferences (these are immediate, and based on the specified structure of the models). Afterwards

### Build:

At each step (greedy algorithm)
Pick the next edge (for subset) to evaluate based on “high potential value due to connecting two long chains for transitive relations, and recent use”.

Evaluate, make inferences again

### Update:

LRU: When we access a relation, we implicitly access all its currently known transitive components (for transitive relations).
For small I-structures, we can update the time of last use of all the inner transitive links (O(N2), for N I-structure nodes), and for large ones, only the counters of the longest transitive chain (the kernel), or a combination.
We cannot store explicitly all O(N2) transitive edges (for subsets, information equivalences, . . . ). For 10000, polytopes, we get 100 million edges:
   We label each node with the id of the chain it is in, and its rank in the chain update the rank lexicographically, when the I-structure is updated.
   When two chains merge to yield a longer chain, then the labels of the 2^{nd} chain are equated to the labels of the first (we can store the equivalences in a hash table).
   Essential we are implementing a union-find-datastructure, well known in the state of art.

### Replace:

We have the exact value of an edge (ignoring future usage uncertainties). We replace low value edges first.

Clearly build-update-memory optimization is a technical improvement, reducing the processing time, power, and storage needs.

FIG. 40 shows optimizers responsible for optimizing build, update and storage (in memory) of I-structures. The build optimizer F40_BO_100 chooses an optimal ordering of nodes for building the I-structure. The update optimizer F40_UO_100 handles merging and splitting of nodes (analogous to a B-tree) on arrival of new data points. The memory optimizer F40_MO_100 handles value-based replacement of nodes.

### 11. OUTPUT INTERPRETATION IN GANAKA: CONVEX MODELS AND SUMMARIZATION

There is a deep relationship between set theoretic relational algebra in Ganaka, and data analytics exemplified by summaries (averages, variances, etc).
Definition: A summary is defined to be a weighted average of input data points—a convex combination of (blocks of) the input datapoints. The summary polytopes are subsets of the convex hull of the respective datapoints. These summary polytopes can be expanded to cover the entire convex hull of the respective datapoints.

Theorem: Convex summaries are subsets of the (convex hull of) data/polytopes they summarize.
The proof is easy convex summaries are convex combinations of the data points, and hence fall inside the convex hull of the datapoints/polytopes which include them. For example, in FIG. 41 summary polytope 102 is a subset of the convex hull of the datapoints 101, and polytope 104 is a summary and subset of 102.

Important special case of summarization are:
Sampling every kth element in the input data.
Averaging part or whole of a data block

Yᵢ=Σᵢxᵢⱼ
Weighted averaging of part or whole of a data block

Yᵢ=Σᵢwᵢⱼxᵢⱼ

Checking two subsets (using linear/integer linear programming), corresponding to summaries for two data sets A and B, for disjoint/intersection/subset relationships yields answers for relationships between summaries for A, B, having various combinations of percentage weights. The set theoretic relation is simultaneously checked for all combinations of percentage weights yielding the respective subsets (as opposed to testing a single weighted mean of the point data in A and B). This procedure can also give constraints on percentage weights for disjoint/intersection/subset relations to hold.

The convex summaries are themselves convex polyhedra (or convex bodies) and can themselves be stored in the memory system (or cMdB in a database embodiment). These summaries can themselves be summarized, leading to a hierarchical summarization (e.g. CS102 and 105 in FIG. 41), which parallels an associated 1-structure. Pointers between the data and the summaries can be exemplarily maintained in the memory system/CMdB. Similarly, a convex summary of the intersection of two polytopes can be used as a joint summary, . . . .

In FIG. 41, the input data points are blocked, and a block (numbered 10) (F41_IB_100) is converted to a model stored in the memory system/CMdB 100 (F41_CM_100), in one or more tuples. The data points in the block are enclosed in the class convex hull (or exemplarily convex superset thereof) 101 (F41_CH_100). Convex summaries 102 (F41_CS_100), 103 (F41_CS_200) (exemplarily human understandable), 104 (F41_CS_300), and outer convex summary 105 (F41_OS_100) are also linear, forming polytopes, and associated with the class polytopes. The I-structure 106 (F41_IS_100) has links reflecting these relationships (not shown). Summary polytopes may exemplarily be stored in the same memory system/CMdB or another memory system/CMdB. These summaries are produced by the summarizer 107 (F41_SR_100), which implements the methods given in “Analytically Tractable Summaries” (Section 12.1 below). Summaries are not necessarily polytopes but may be general preferably convex bodies in an appropriate feature space.

11.1. Analytically Summaries

The summaries can be chosen to be simple regions, analytically tractable. The computer system embodiment has software/hardware modules to determine these summarizes, based on the equations below.
These modules can be triggered automatically on input of data, and/or arrival of new data
Different modules can be run in parallel on multiple cores, simultaneously offering multiple summaries.

Exemplarily these summaries can be polytopes, chosen to have a small number of facets—e.g. they may be just rectangular hypercubes. For example, a restricted hypercube around the centroid can be maximized in size using the linear program:

$$r \\ such that \\ {y}_{i} = {\sum }_{j} {w}_{i j} {x}_{i j} \\ 0 \leq {w}_{i j} \leq 1 \\ - r \leq {( {y}_{i} - \frac{1}{m} {\sum }_{j} {x}_{i j} )}_{k} \leq r \\ k = 1 , 2 , … , n ; i = 1 , 2 … , \frac{N}{m} ; j = 1 , 2 , … , m \qquad ( 1 )$$

Where, n is the dimension of the data points, N in the total number of data points in the complete data series (N is typically large) and m is the number of data points considered for each convex summary.

Each point in this hypercube is a skewed percentage combination of the original data-series. The skew in percentage combinations can be limited by adding the constraints

$${w}_{ij} \leq \frac{1}{N} + {Δ}_{i} \\ {w}_{ij} \geq \frac{1}{N} - {Δ}_{i}$$

This is again a linear program.

The summaries can also be a hyperoctahedron. The constraint equations in (1) are replaced by:

$${\sum }_{k} \vert {( {y}_{i} - \frac{1}{m} {\sum }_{j} {x}_{ij} )}_{k} \vert \leq r ∀ i$$

Or a sphere, the constraint equations are (now we get a Quadratic program):

$${‖ {y}_{i} - \frac{1}{m} {\sum }_{j} {x}_{ij} ‖}_{2} \leq r ∀ i$$

Or an ellipsoid (again a quadratic program results):

$${( {y}_{i} - \frac{1}{m} {\sum }_{j} {x}_{ij} )}^{T} Q ( {y}_{i} - \frac{1}{m} {\sum }_{j} {x}_{ij} ) \leq {r}^{2} ∀ i$$

Such a device enables comparisons between the averages and set-theoretic relationships between two series, without restricting the representation of the series to a single point.

An appropriate visual representation can be the graphical visualizer as per our earlier patents and patent applications.

C100, shown in FIG. 42, is the convex hull of all the data points in the original data series. H101 shown in FIG. 42(a) is a maximal hypercube of the summaries within the convex hull C 100. E102 shown in FIG. 42(b) is a maximal ellipsoid of the summaries within the same convex hull of the original data series.

Based on the above considerations, in general, If the summaries are chosen to be human understandable—substitutive/complementary constraints, then we get a computer/memory/database, which can “explain and explore” the data.
We have shown rectangular boxes, hyperoctahedrons, hyperspheres, and hyperellipsoids,
   The structure of these solids simplifies both set theoretic and information theoretic operations, since analytical derivations exist (no LP's are needed).
      Further, in the case of a conical rectangular prism, e.g. in 3D, the dimensions of the rectangular region (in say, x and y) vary linearly as a function of the third variable (z). The rectangular variation in x and y (even if a function of z), simplifies both set-theoretic and information theoretic operators.

It is evident that summaries can be used when possible, instead of the actual data for analysis increasing speed, reducing power, . . . . A summary polytope or convex body, is a much simpler description than the ensemble of data points, and more descriptive than an average. Analysis can be done in parallel using different summaries, on different cores, in a multi-core architecture.

Another importation data analytics parameter is the cross-correlation between two random variables/series. In Set-Theoretic Terms, this can be approximated by the % of common volume, estimatable by several methods like MCMC, . . . .

### 12. GANAKA: NONLINEAR TRANSFORMATIONS AND INFORMATION THEORETIC EQUIVALENCES, NONLINEAR INVERSIONS

As per our earlier patents and patent applications referring to databases, and also applicable to Ganaka, we derive new series equivalent to old data, in an information theoretic sense. In a classification scenario, this means that a new class can be derived, which is equivalent to an old class, in terms of the volume of the space of parameters occupied. In a probabilistic interpretation, this implies that the new class has the same probability as the old.

This is compression of data (only one materialization as per our previous patent/patent applications need be stored), and also reduces power, if we store only a succinct summary.

Our earlier work performed information equivalent transformations in linear models. This invention extends this facility to include non-linear models, where the transformation is applied in the linear space obtained after the nonlinear transform.
In the case of linear models, orthogonal transformations are one method, as per the prior art.
In the case of nonlinear models, defined by polyhedra in nonlinear feature space, we have orthogonal and other volume preserving transformations in the nonlinear feature space.
In the case of graphical models, methods to estimate the partition function and probabilities can be used to transform a new event B can be created, and changed iteratively, till it has the same probability as an original event A. This corresponds to having the probability weighted volume of the subset of sample space (i.e. the measure) corresponding to B, equal to the probability weighted volume of the subset of sample space corresponding to event A.

12.1. Class Morphing Ability

The ability to perform nonlinear transformations yields a device which can morph general classes, keeping the same volume. As an example, FIG. 44 shows a non-linear feature extractor N100 coupled with the CMdB C103. The original data point, image 101, is transformed to a set of features using N100. These features are stored in the CMdB as polytopes or convex bodies or graphical models. These models are then transformed using the above methods. A new feature vector is sampled from the transformed region or model. This feature vector on inverse mapping using N100 produces a new data point 1102. For example, if the original input data points are faces, then the inputs mapped to the new features may correspond to faces with different facial features, poses, and expressions.

12.2. Non-Linear Feature Extraction and Inversion of Features

The above figure shows a non-linear feature extractor, which takes four-dimensional vectors as inputs, derives features using non-linear transformations such as sigmoid, RELU (non-linearities are denoted by the transformation f) . . . and produces two-dimensional feature vectors for every input.

Consider an input (x₁, x₂, x₃, x₄) to the non-linear feature extractor.

In the forward pass, the first layer outputs are given by:

$$y = f ( {W}^{( 1 ) T} x ) ( or )$$

$${y}_{j} = f ( {\sum }_{i} {w}_{ij}^{( 1 )} {x}_{i} )$$

The final layer features are given by:

$$z = f ( {W}^{( 2 ) T} y ) ( or )$$

$${z}_{j} = f ( {\sum }_{i} {w}_{ij}^{( 2 )} {y}_{i} )$$

Given a sample in the feature space (z space), it is possible to produce new input samples using non-linear optimization methods, since the non-linear feature transformation is a many-to-one mapping. Consider a sample (z₀,z₁) in the feature space. On the inversion of non-linearity, we have:

u₁=f⁻¹(z₁)=Σᵢwᵢ₁⁽²⁾yᵢ and

u₂=f⁻¹(z₂)=Σᵢwᵢ₂⁽²⁾yᵢ

Since yᵢ s are outputs of the non-linear functions, these will typically be constrained. For example, if the sigmoid non-linearity is used,

0≤yᵢ≤1∀i

For the non-linear model shown in FIG. 45, this system has two equations and three unknowns (underdetermined system). Therefore, there can be several possibilities for y. These different values of y on one more inversion step can produce new image samples.

The second inversion step to generate new samples in input space,

v₁=f⁻¹(y₁)=Σᵢwᵢ₁⁽¹⁾xᵢ,

v₂=f⁻¹(y₂)=Σᵢwᵢ₂⁽¹⁾xᵢ and

v₃=f⁻¹(y₃)=Σᵢwᵢ₃⁽¹⁾xᵢ

The inputs may also be constrained, for example, images (unnormalized) have pixel values between 0 and 255,

0≤xᵢ≤255∀i

This system is also underdetermined with 3 equations and 4 variables. Hence, different possible input samples can be generated from the same feature sample z.

12.2.1, Applications of Nonlinear Inversion

Nonlinear transformations can be considered in the realm of classification, regression, and in general any machine learning application. We illustrate uses in classification.

A new sample which belongs to the same class as represented by the feature vector z can be generated using the minimization criterion:

∥x−o∥₂

Where x is the input sample to be generated using the above linear equations/constraints and a is a sample belonging to the class represented by the feature vector z.

Adversarial examples can also be generated using a minimization criterion, such as,

∥x−a∥₂

Where x is the input sample to be generated using the above linear equations/constraints and a is a sample belonging to a class other than the class represented by the feature vector z. We can also generate samples which are close to any data point not present in the original dataset, by choosing an appropriate sample a (Section 13.2.2 has an example).

Some more applications include
The non-linear feature inversion module can be used to test the robustness of the non-linear model by generating adversarial examples or examples which do not belong to any of the classes.
The nature of adversaries on varying attributes of the non-linear feature extractors: architecture, number of hidden units, number of layers, non-linear function, . . . , can be studied. The change in adversaries for different classifiers can be studied.
Adversaries can be generated using a different minimization criterion: L₁ distance norm, L∞norm . . . .
We can also improve speed and reduce power consumption, by reducing the accuracy of the calculations (say, 4 bits instead of 8-bits), and observe the behavior of adversaries.
In conjunction with memory system/CMdB non-linear transformations, these inversions can be used to map features in the transformed space to the input space.
It can also be used to understand the effect of inversion on feature vectors which lie in the intersection of two or more different classes.

12.2.2. Confusable Inputs

The same facility can be used to test if the classifier is robust, in that small changes to features at the classification (final) layer, do not change the input dramatically i.e. very different inputs don't have a risk of being classified together (checking if confusable inputs exist).

FIG. 46 shows how the same feature in feature space, when inversely mapped to the input space can produce inputs, but one of them belonging to a certain class in the original input space and the other belonging to another class in this space/not belonging to this space. In the illustration, x0 is a point in the input space, x1 belonging to none of the original classes. However, the neural network produces the same outputs (features) for both points x0 and x1. With the one-to-many inverse mapping of neural networks we can construct confusable inputs, such as the point x1 shown in the Figure.

The ability to invert nonlinear transformations yields a device, which given original data in a certain class, produces new data corresponding to the same class, or a selected different class. The new data can be forced to “resemble” original data according to a metric.

### 13. PROGRAMMING INTERFACE FOR GANAKA

The large number of facilities in Ganaka can be automatically scheduled (using exemplarily machine learning, and/or controlled using a programming language interface. The programming language interface, implemented by the controller in FIG. 12 and FIG. 13 specifies the sequences the use of either point data, models, or both.

An exemplary API and program to determine where the convex and graphical models agree on a datablock BL is shown below. After determining the agreement set, the program updates the I-structure, calculate the points of agreement of modules, summarize it, visualize it, and invert to get another datablock where both models agree, is shown below (and can be built on top of RISC/CISC architectures, as per the current state-of-art). Both blocks (if size is less than a threshold), and models are sent over an i/o link.

FIG. 487 Ganaka Program

```
BL=get_next_data_block( )
A=convex_model(BL)
B=graphical_model(BL)
If (!presentInIstructure(A&B)) {
  C= A &B
  If (furtherExpressionsInvolving(C)) {
    storeIStructure(C)
    makeSummary(A, C);
    visualize(C);
    BL1=invert(C);
    Send(C, Destination);
    If (size(BL1) <= Threshold)
      Send(BL,BL1, Destination);
  }
}
```

### 14. NAMESPACE TRANSLATION

The namespace translator/manager generates the variable namespace for any given domain. Often applications belonging to different domains require domain specific variables. It uses various variable attributes such as time attribute or component attributes specified by the input while generating the variable namespace. This namespace will then be used for creation of constraints for the polytopes.

It also enables variables of different polytopes to be optionally equivalenced. For example, a translation x->y, where x is a variable in polytope P1 and y a variable in P2, implies that the constraints having x in P1 are transformed to y in P2, and all database operations are based on this equivalence. However, this is possible only if a one-to-one mapping exists between these variables.

When two polytopes P₁ and P₂ being compared are in the same space Rn, (or Zn if there are integrality constraints) then the disjoint, subset and intersection operations are directly definable as shown in the methods mentioned above. But, when they are defined in (possibly partially) different spaces (say, due to arising in different applications), then other techniques will have to be additionally performed to do the same. Let P₁ be defined as a subset {R₁^{K}^{₁}×R₂^{N}^{₁}^{-K}^{₁}} and P₂ be a subset of {R₂^{K}^{₂}×R₁₂^{N}^{₂}^{-K}^{₂}}. Thus P₁ is defined as an N₁ dimensional polytope composed of (a) K₁ variables unique to P₁ and (b) N₁−K₁ variables shared with P₂. Similarly, for P₂.
The simplest method is to consider that the polytope P₁ extends infinitely in the dimensions defining P₂, and vice versa. Thus, both polytopes are extended to a new space of dimension (K₁+K₂+(N₁−K₁,N₂−K₂)). The extensions P₁E/P₂E of P₁/P₂ are hence defined as

P₁E=[P₁,R^{K′}],K′=K₁+(N₁−K₁,N₂−K₂)−(N₁−K₁);

P₂E=[P₂,R^{K″}],K″=K₂+(N₁−K₁,N₂−K₂)−(N₂−K₂)

The operators are applied in this new space. Essentially, we are creating “cylinders” whose “cross section” are P₁/P₂ respectively.
Another method could be to project the two polytopes onto common dimensions and then apply the operators on them. Instead of projections, sections can also be taken. Another method would be to map the variables/dimensions in one on to the other if there is a one-to-one mapping between the two. Alternatively, both can be mapped to an underlying abstract variable/dimension.

The interaction between the namespace manager, the application and the CMdB is illustrated in FIG. 48 below.

The dotted lines in the figure indicate the flow when an operation between polytopes of different domains/namespaces needs to be performed. In this case, the application initiates such an operation. The CMdB after checking permission rights to the application for the required tables in the operation, sends a request to the application for the necessary namespace translation. This request is forwarded to the namespace translator which translates the required variables and polytope information and sends it back to the application. These results are then forwarded to the CMdB which uses it for subsequent query operations.

### 15. GANAKA APPLICATION: RAILWAY SCHEDULE CONFLICT VALIDATION

An application of Ganaka's capabilities to train timetabling is given below.

The Train Timetabling Problem (UP) is a complex problem where the objective is to find a conflict-free schedule for trains on a given railway network satisfying some operational constraints and maximize the efficiency of infrastructure usage.

The deterministic optimization problem is itself NP-hard, but small pieces are amenable to state-of-the art MILP solvers. When uncertainty is introduced, the computations become intractable even for small pieces of the network. However, we present a simple and elegant solution to validate feasibility of a given schedule, under global correlated variations/uncertainty in travel times and distances. Train arrival and departure times at each block section can vary between a minimum and a maximum value and correlation between arrival/departure times at different times, can be represented by an ellipsoid at the k th-percentile, if the joint probability distribution function is Gaussian. This ellipsoid can be approximated by a polyhedron/polytope by specifying various complementary and substitutive constraints which are intuitive.

Analogous to less than/equal to/greater than relations for totally ordered entities, set-theoretic relations between two polytopes/convex body entities are subset/disjoint/intersection, and the property of a single entity quantifying information content, is the (multidimensional) volume. The following relationships between the polytopes are indicative of conflicts that can occur along a route.
15.1. An intersection between two polytopes indicate if two trains conflict globally along a route or specifically on any block section. Global intersection means it conflicts all along the route and intersection on a block section means conflict in arrival and departure time only in that specific block section.
15.2. Disjointness between two polytopes indicates that the trains will not conflict along a route. The minimum distance (Euclidean or otherwise) of one train polytope from the other is a measure of the schedules margin and robustness.
15.3. If one train is a subset of the other, it indicates that the set of arrival or departure times of one train in the schedule is encompassed by the set of arrival or departure times of the other train and the two trains can be merged.

The above-mentioned schedule validation techniques were applied on a small portion of railway data. In the example, we considered more than 100 trains along a major section of a national operator and generated a polytope for each train. These polytopes where then analyzed to check if there could be a global intersection between the trains along the route or if there could be an intersection between two trains at any block section along the route after delays were introduced into their travel times. Our results have shown around 5% of trains can intersect along a route with 10% of delay in train arrival and departure times. This increases to 15% with 50% delay in the arrival and departure times. Our validation results assume only the support of the arrival/departure time distribution and are valid for any arrival/departure distribution with the same (finite) support—we produce distribution independent global bounds. Taking best/worst/average case scenarios at best analyses three samples of the infinite set of arrival/departure timings possible.

FIG. 49 shows a system that iteratively changes the schedule to eliminate conflicts and maximizes schedule separation in a non-probabilistic method. A larger schedule separation implies trains can run at a higher speed, possibly more efficiently and using less fuel without relying on probability.

### 16. GANAKA APPLICATION: MOTION CONTROL

With reference to the U.S. Pat. No. 7,348,754 “Motion Control Using Electromagnetic Forces” and succeeding US and Indian ones, we can model emecs and optimize/design them.

### 17. GANAKA APPLICATION: FINANCIAL COMPUTATIONS

Ganaka can be applied to many domains, including finance e.g. inferring low risk classes of derivatives, investments, checking if one set of investments is uniformly better than another, . . . . In finance, there are additional considerations, in that calculations have to be made in decimal arithmetic, and this extension of Ganaka is described below. Ganaka implements decimal arithmetic with minimal changes to a standard IEEE754 binary compliant ALU.

Finance is a major user of arithmetic but has to conform to a uniformly-spaced decimal grid for transactions (not for analytics/optimization/Machine Learning (ML), IEEE-754 has a log-spaced grid.

Computations in financial applications can range from transactions (deposits, withdrawals, currency conversion, interest calculations) to statistical methods for analysis of financial time series, optimization for portfolio management and ML for derivatives pricing and predicting future values of assets. Our work shows how a slightly modified conventional processor conformant to IEEE-754-2008 binary specifications, can handle this mixed workload, and how it can be slightly enhanced to improve further. FIG. 1 FIG. 50 Error! Reference source not found. shows the mismatch of the real numbers represented by IEEE-754 compliant binary floating-point units and real numbers used in finance. The real numbers used in finance are typically large numbers with 2-3 precision uniformly spaced fractional grid. In IEEE-754 floating point, however, the fractional grid is logarithmically spaced.

The basic financial transaction operations are deposits (additions), withdrawal (subtractions), currency conversions and interest calculations (multiplication/exponentiation). Interest calculations can be simple interest or compound interest. However, the results have to be accurate as per the equi-spaced financial grid, not a logarithmically spaced IEEE-754 grid.

Often a financial application used data stored in solid-state-disks (SSD's), for high transaction throughput, and this impacts the architecture.

17.2. Sequence of a Typical Workflow

Input transformations: Input transformations involve conversion of the decimal string (data format A) to the widest integer data type (long long integer—data format B), after pre-multiplying by an appropriate power of 10. Essentially, we have morphed the input from the decimal representation to a finite representation (integer and precision) which can be handled by the ALU operating in the binary domain. Such transformations are possible in financial applications because the domain of financial calculations is a subset (smaller dynamic range up to 35 digits) of the domain of floating point arithmetic. Excess digits can be dropped as per financial rules, since repeated currency rounding is legally allowed for financial transactions. This is not true for general floating-point arithmetic.

Decimal Arithmetic Calculations. The core arithmetic calculation is an addition, subtraction or multiplication in binary, which is directly implemented by the binary FPU. This unit also performs additional binary operations for book-keeping the precision and checking for dynamic range.

Output transformations. Reverse transformations from binary formats to decimal string are relatively simple. The limitation here is typically the string conversion overhead. Digit-by-digit traversal of the binary number for conversion to a decimal string is slow and the string processing overhead in the overall workflow becomes high. The output string conversion process is speeded up by using a lookup table which stores string representations of a finite set of integers. The method begins with an entity in the transformed domain (integer and precision). The entity is split into integer and decimal portions, by division and modulo by 10^{precision}. Each of these portions are then chunked, using modulo/division by powers of ten. The string representation of each chunk is read from one of the four look-up tables, corresponding to 1, 2, 3 and 4 digit integers respectively, depending on the range in which the chunk lies, as shown in FIG. 51 Error! Reference source not found. FIG. 52 Error! Reference source not found. shows an example for the look-up table method. The red arrow indicates the chunk 123 (obtained after two preceding division and modulo operations), the string representation for the same is read from the look-up table storing representations of 3-digit numbers, indicated by the blue arrow.

Further performance optimizations are achieved using vectorization of operations and parallelization of input and output transformations. Sequential operations, which is required for compound interest calculations and day-end/month-end calculations are also implemented.

17.3. Currency Rounding

The rounding implemented here is specific to currency with only 2 or 3 precision, different from IEEE-754 rounding rules (eg. round to nearest) and hence does not involve their complications (the number of decimal digits can be arbitrarily large). Rounding rules differ based on the lowest denomination of the currency in circulation. Rounding in finance always does not reduce the precision, for example, in the Argentine Peso. Our methods implement rounding rules for a number of currencies: the Indian Rupee, the Japanese Yen, the US Dollar, the Euro, the Argentine Peso and the Swiss Franc. The rounding procedure can have two possible instantiations: the first is to round in long long and the second is to round during data translation. FIG. 53 Error! Reference source not found. shows the hardware realizations of a simple currency rounding unit.

17.4. Hardware Extensions

As long as the transformed decimal lies within the dynamic range of binary formats, our methods are fast and correct. Outside the dynamic range, we use bounding methods, similar to Unum. These bounding methods use the existing binary hardware and compute upper and lower bounds on the results. Only if the bounds differ (rare), we make calls to GMP software package. The comparisons for dynamic range checks and additions/subtractions/multiplications can be pipelined for further gains. When the dynamic range checks fail, a flag is set for subsequent calls to upper-lower bound methods or GMP methods. The pipeline need not be stalled or flushed.

However, with suitable hardware extensions or assembly language kernels, the few calls to GMP can also be avoided. 128/256-bit binary data formats with provisions for carrying over 64-bit addition carry-borrows significantly increases the range of values that our methods can handle and covers all the possibilities for deposits/withdrawals. For multiplications, the longer or both operand(s) has to be partitioned to upper half and lower half and the result of multiplication of these halves with the multiplier (the smaller length interest rate/currency conversion rate) has to be multiplied by a power of ten and added, using possibly the 128/256-bit add/subtract. With these data formats, our methods can handle numbers in the range [−2¹²⁷, 2¹²⁷−1]/[−2²⁵⁵, 2²⁵⁵−1]. Numbers with up to 35 digits are supported with 128-bit and numbers with up to 75 digits with 256-bit data formats.

While financial transactions require extended precision, other financial applications such as risk analysis and derivative pricing can work with reduced precision. In such cases, the numbers stored in the extra precision bits are treated as distinct entities. For example, a 256-bit data type can be divided to 4 partitions of 64 bits, and each of these partitions is used to store a reduced precision number. Hence, we can simultaneously perform 4 calculations with the extended precision data type. This requires hardware logic to switch on/off the carry propagation to the extended precision bits. In this case, the switch is implemented as a conditional AND as shown below at the bit positions 32, 48, 64 and so on.

C=C_{raw}\hat{ }mode

where, C is the final carry bit, C_{raw} is raw propagated carry from the previous entity and mode is the mode of operation (transactions or analytics/optimization/ML). The extra precision bits, thus, can be used resourcefully for reduced precision applications.

Our architectural recommendations for a binary ALU suitably modified for financial operations include:

1. A data translation unit. This unit will typically have to fetch the inputs from a database structure, hard disk, solid state disk or a densely packed decimal and convert the data to the internal data structure used by the arithmetic operations.
2. The internal ALU will be a conventional ALU with possibly small enhancements
3. Reverse data translation unit, which converts the data structure back to the output data format.
4. A currency rounding unit which can be micro-coded.

### REFERENCES

1. Scaling log-linear analysis to high-dimensional data, Francois Petitjean, Geoffrey I. Webb and Ann E. Nicholson, {francois.petitjean.geoff.webb.ann.nicholson}@monash.edu IEEE ICDM 2013
2. Judea Pearl

### 18: COMPUTER ANU—ATOM

[symbol] is a complete bit-slice, and extends Ganaka's capabilities by adding multi-display visualization. It tries to extend the scalability ideas to all components processor, memory and i-o/human-computer interface. Most of the ideas are standard, except for the scaling of the human-computer interface.

The major components of [symbol] are:
2. A Multi-core architecture supporting high degree of task parallelism.
3. Banked Memory Hierarchy with one of the classical coherency semantics.
4. Scalable I/O communication channels, keyboard, speakers, display
   a. Some challenges

1. A system, operating on succinct models of datapoints, having facilities

1. Generating said data models from said datapoints.

2. Computing set- and information theoretic relations between at least two data models,

3. Speeding up said set and information theoretic computation using an inference-structure (I-structure), by first accessing the I-structure before algorithms are tried for said relations

4. Storing said I-structure entries partially in a register-file, L1 cache, L2 cache, enabling single cycle operand access for entries in the register-file.

5. Flushing I-structure entries from the register-file, L1 cache, L2 cache.

6. Modifying said I-structure entries and storage location upon changes in said models,

7. Reducing memory used for said models, by taking a convexified reduced facet representation of the set-union of at least two models, and replacing both models by said set-union, in a memory management device, said memory management device offering the facilities of allocation, compaction, and deallocation of memory.

8. . . .
